(19) United States
(12) Patent Application Publication
(10) Pub. No.: US 2023/0413746 A1
(43) Pub. Date: Dec. 28, 2023

(54) ROBOT-ASSISTED DEEP WATER CULTURE HYDROPONICS

(71) Applicants: Lawrence BODONY, Charlestown, MA (US); Umberto SCARFOGLIERO, Charlestown, MA (US); BOUNDLESS ROBOTICS, INC., Charlestown, MA (US)

(72) Inventors: Carl Eric Palme, Charlestown, MA (US); Lawrence Bodony, Lexington, MA (US); Aidan Ulysses Cookson, Rowley, MA (US); Daniel Scott Cookson, Rowley, MA (US); Silas Hughes, Cambridge, MA (US); Umberto Scarfogliero, San Carlos, CA (US)

(21) Appl. No.: 18/038,958

(22) PCT Filed: Nov. 24, 2021
(86) PCT No.: PCT/US2021/060846

§ 371 Date: May 25, 2023

Related U.S. Application Data
(60) Provisional application No. 63/242,189, filed on Sep. 9, 2021.
(60) Provisional application No. 63/118,893, filed on Nov. 28, 2020.

(51) Int. Cl. A01G 31/02; A01G 7/04; G05B 13/02

(52) U.S. Cl. CPC A01G 31/02; A01G 7/045; G05B 13/0265; A01G 2031/006

(57) ABSTRACT

Techniques for robot-assisted deep water culture hydroponics are disclosed, including: receiving status data from multiple apparatuses associated with hydroponic cultivation, applying the status data to a machine learning model to determine one or more hydroponic cultivation parameters, and transmitting, to one or more of the apparatuses, one or more instructions to modify a hydroponic cultivation process according to the one or more hydroponic cultivation parameters.

### RELATED APPLICATIONS

This application claims the benefit of U.S. Provisional Patent Application Ser. No. 63/118,893, titled “NOVEL METHOD AND APPARATUS FOR GROWING PLANTS IN A DEEP WATER CULTURE ENVIRONMENT,” filed Nov. 28, 2020, and U.S. Provisional Patent Application Ser. No. 63/242,189, titled “ROBOT-ASSISTED DEEP WATER CULTURE HYDROPONICS,” filed Sep. 9, 2021, both of which are hereby incorporated by reference in their entireties for all purposes.

### BACKGROUND

By some estimates, as of August 2021, about 12% of Americans consume cannabis daily or almost daily. Recreational use of cannabis is legal in 18 states (plus the District of Columbia) and medical use of cannabis is legal in 36 states. FIG. 4 shows charts of the proportion consumers who would grow cannabis at home if it were legal in the United States, by age group and region respectively. As more people discover the benefits of cannabis and the importance of quality, cannabis consumers will turn to home growing more and more. Home growing of cannabis is exploding on the marketplace. However, for indoor cannabis growing to gain mass-market acceptance, reliable growing techniques are needed.

Deep Water Culture (DWC) hydroponics is a popular approach to growing plants indoors, due to the speed at which plants may be grown and the high quality of the yield. However, when the wrong nutrients are applied or the water is not closely monitored for pH levels, the plant can suffer irreversible harm or death. Ensuring that the right nutrients are applied at the right time and in the right quantities is crucial to ensuring the right pH of the water and the overall success of a DWC harvest.

In some cases, indoor growing uses a grow tent, enclosing the plant, providing a controlled environment, and removing odor. However, for the retail home growing market, it is challenging to create a visually appealing tent. In addition, when using a tent, the plant itself is obscured from the consumer's view unless a viewing window of some sort is provided.

Approaches described in this section have not necessarily been conceived and/or pursued prior to the filing of this application. Accordingly, unless otherwise indicated, approaches described in this section should not be construed as prior art.

### TECHNICAL FIELD

The present disclosure relates generally to hydroponics.

### SUMMARY

### A. Hydroponic Cultivation Apparatus

In general, in one aspect, a hydroponic cultivation apparatus includes: multiple water receptacles configured to store water at different states associated with hydroponic cultivation; one or more pumps configured to transport water between water receptacles in the multiple water receptacles; a nutrient delivery mechanism; multiple sensors configured to obtain sensor data associated with at least the multiple water receptacles and an external environment of the hydroponic cultivation apparatus; and a controller configured to control operation of the one or more pumps and the nutrient delivery mechanism, based at least on the sensor data.

The hydroponic cultivation apparatus may further include a wired communication interface and/or a wireless communication interface, and the hydroponic cultivation apparatus may be configured to (a) transmit the sensor data to a grow management service and (b) receive instructions usable by the controller from the grow management service, via the wired communication interface and/or the wireless communication interface(s).

The controller may be configured to control operation of the nutrient delivery mechanism at least by controlling timing of nutrient deposits by the nutrient delivery mechanism.

The controller may be configured to control operation of the nutrient delivery mechanism at least by controlling amounts of nutrient deposits by the nutrient delivery mechanism.

The controller may be configured to control operation of the one or more pumps to obtain particular water levels in the multiple water receptacles.

The controller may be further configured to control operation of the one or more pumps and the nutrient delivery mechanism based on data gathered by a grow management service from a network of hydroponic cultivation apparatuses.

The hydroponic cultivation apparatus may further include at least one environmental control mechanism, the controller may be further configured to control operation of the at least one environmental control mechanism to modify the external environment of the hydroponic cultivation apparatus, based at least on the sensor data.

The hydroponic cultivation apparatus may further include a data repository configured to store at least the sensor data.

The hydroponic cultivation apparatus may further include a user interface configured to perform one or more of (a) presenting data for monitoring operation of the hydroponic cultivation apparatus or (b) receiving user input for managing operation of the hydroponic cultivation apparatus.

The hydroponic cultivation apparatus may further include a wired communication interface and/or a wireless communication interface, and the hydroponic cultivation apparatus may be configured to (a) transmit data to a user interface presented at a user device and (b) receive instructions from the user interface for managing operation of the hydroponic cultivation apparatus, via the wired communication interface and/or the wireless communication interface(s).

The controller may be configured to manage operation of the one or more pumps to balance water in at least one water receptacle in the multiple water receptacles, by performing one or more of (a) adjusting a concentration of one or more nutrients in the water, (b) adjusting pH of the water or (c) adjusting total dissolved solids of substances in the water, which may be measured in parts per million (PPM). Adjusting the pH of the water may be performed without obtaining data from any sensor configured to specifically measure the pH. Adjusting the PPM of the substance in the water may be performed without obtaining data from any sensor configured to specifically measure the PPM of the substance.

The controller may be further configured to drive power and one or more signals to one or more external peripherals.

The controller may be a node in a distributed system of multiple hydroponic cultivation apparatuses, aggregate data from the multiple hydroponic cultivation apparatuses being used in machine learning to improve a hydroponic cultivation process.

The controller may be configured to operate according to instructions received from a grow management service operating in a remote network.

The controller may be configured to transmit data to data storage located in a remote network.

The controller may be configured to control operation of the one or more pumps so that water reaches room temperature in a fresh water receptacle in the multiple water receptacles.

The fresh water receptacle may be disposed so as to allow off-gassing of waste products while water is in the fresh water receptacle.

The controller may be configured to control operation of the nutrient delivery mechanism by depositing small amounts of nutrients periodically as a plant demands water from a fresh water receptacle in the multiple water receptacles.

The controller may be further configured to communicate with a lighting apparatus to control light emitted by one or more light sources toward a plant. The lighting apparatus may be part of the hydroponic cultivation apparatus. The lighting apparatus may be physically coupled with the hydroponic cultivation apparatus.

### B. Lighting Apparatus

In general, in one aspect, a lighting apparatus includes: one or more light sources configured to emit light at one or more wavelengths for hydroponic cultivation; one or more sensors configured to obtain sensor data associated with a plant; and a controller configured to control operation of the one or more light sources, based at least on the sensor data.

The lighting apparatus may further include a wired communication interface and/or a wireless communication interface, the lighting apparatus being configured to (a) transmit the sensor data to a grow management service and (b) receive instructions usable by the controller from the grow management service, via the wired communication interface and/or the wireless communication interface(s).

The sensor data may include data associated with a status of the one or more light sources.

The sensor data may include data associated with an external environment of the lighting apparatus.

The one or more sensors may include one or more cameras, and the sensor data may include image data including one or more of still images or video.

The controller may be further configured to (a) analyze the image data to detect appearance of an object in a field of view of the one or more cameras and (b) initiate an anti-blinding protocol responsive to detecting the appearance of the object.

The one or more cameras may include one or more of a visible light camera, an infrared camera, or an ultraviolet illumination camera.

The controller may be further configured to analyze the image data to determine a status of a plant.

The status of the plant may include one or more of: shape, height, and/or width of the plant over time; number of branch nodes; colors and/or sizes of eminences; leaf blemishes; motion of internal nutrient flow in the plant; an insect or other predator; mold; spores; nitrogen content of a leaf of the plant; photosynthetic efficiency of the leaves; or thermal contours of a canopy of the plant.

The lighting apparatus may further include at least one environmental control mechanism, the controller being further configured to control operation of the at least one environmental control mechanism to modify the external environment of the lighting apparatus, based at least on the sensor data.

Modifying the external environment of the lighting device may include modifying one or more of light, heat, humidity, carbon dioxide level, airflow pattern, artificial rain, or filtering odor of air near the lighting apparatus.

The controller may be further configured to control a heat source and/or a dehumidifier for drying harvested plant. The heat source and/or the dehumidifier may be one of the one or more light sources.

The lighting apparatus may further include a data repository configured to store at least the sensor data.

The lighting apparatus may further include a user interface configured to perform one or more of (a) presenting data for monitoring operation of the lighting apparatus or (b) receiving user input for managing operation of the lighting apparatus.

The lighting apparatus may further include a wired communication interface and/or a wireless communication interface, the lighting apparatus being configured to (a) transmit data to a user interface presented at a user device and (b) receive instructions from the user interface for managing operation of the lighting apparatus, via the wired communication interface and/or the wireless communication interface(s).

The controller may be further configured to drive power and one or more signals to one or more external peripherals.

The controller may be a node in a distributed system of multiple lighting apparatuses, aggregate data from the multiple lighting apparatuses being used in machine learning to improve a hydroponic cultivation process.

The controller may be configured to operate according to instructions received from a grow management service operating in a remote network.

The controller may be configured to transmit data to data storage located in a remote network.

The controller may be further configured to communicate with a hydroponic cultivation apparatus to control one or more operations of the hydroponic cultivation apparatus. The lighting apparatus may be part of the hydroponic cultivation apparatus. The lighting apparatus may be physically coupled with the hydroponic cultivation apparatus.

The lighting apparatus may further include multiple legs configured to situate the one or more light sources above the plant. The multiple legs may be three legs. The legs may be height-adjustable. The legs may each include a respective connector for removable feet of different heights. One or more of the legs may be hollow, in one section or multiple mechanically connected segments so as to permit adjustment to different leg heights. One or more of the legs may include one or more signal wires, disposed inside and/or outside of the leg surface. One or more of the legs may include one or more openings disposed so as to allow airflow into and/or around the plant, to help control an odor of the plant.

The lighting apparatus may further include a trellis to support plant growth.

The lighting apparatus may further include a rack for curing harvested plant.

The lighting apparatus may further include a suspension mechanism for suspending the lighting apparatus above the plant.

### C. Grow Management Service

In general, in one aspect, a system includes one or more hardware devices including one or more processors, and one or more non-transitory computer-readable media storing instructions that, when executed by the one or more processors, cause the one or more processors to perform operations including: receiving status data from multiple apparatuses associated with hydroponic cultivation; applying the status data to a machine learning model to determine one or more hydroponic cultivation parameters; and transmitting, to one or more apparatuses in the multiple apparatuses, one or more instructions to modify a hydroponic cultivation process according to the one or more hydroponic cultivation parameters.

The multiple apparatuses may include multiple hydroponic cultivation apparatuses.

The one or more instructions may include one or more instructions to modify operation of a water pump.

The one or more instructions to modify operation of the water pump may include one or more instructions to obtain a particular water level in a water receptacle.

The one or more instructions to modify operation of the water pump may include one or more instructions to balance water in a water receptacle, by performing one or more of (a) adjusting a concentration of one or more nutrients in the water, (b) adjusting pH of the water or (c) adjusting total dissolved solids of substances in the water, which may be measured in parts per million (PPM).

The one or more instructions may include one or more instructions to modify operation of a nutrient delivery mechanism. The one or more instructions to modify operation of the nutrient delivery mechanism may include one or more instructions to modify timing of nutrient deposits by the nutrient delivery mechanism. The one or more instructions to modify operation of the nutrient delivery mechanism may include one or more instructions to modify amounts of nutrient deposits by the nutrient delivery mechanism.

The multiple apparatuses may include including multiple lighting apparatuses.

The one or more instructions may include one or more instructions to control operation of one or more light sources, which may include controlling an intensity of the one or more light sources.

The one or more instructions may include one or more instructions to control a heat source and/or a dehumidifier for drying harvested plant.

The multiple apparatuses may include multiple hydroponic cultivation apparatuses and multiple lighting apparatuses.

The one or more instructions may include one or more instructions to modify operation of an environmental control mechanism.

The system may further include a data repository configured to store at least the status data.

The operations may further include transmitting data to be displayed in a user interface of an apparatus in the multiple apparatuses.

The operations may further include transmitting data to be displayed in a user interface of a user device communicatively coupled with an apparatus in the multiple apparatuses.

The multiple apparatuses may be configured to perform hydroponic cultivation according to one or more recipes, the one or more instructions including one or more modifications to the one or more recipes.

The operations may further include analyzing image data received from an apparatus in the multiple apparatuses to detect appearance of an object in a field of view of one or more cameras; and initiating an anti-blinding protocol responsive to detecting the appearance of the object.

The operations may further include analyzing image data received from an apparatus in the multiple apparatuses to determine a status of a plant.

### D. Instructions for Controlling Operation of a Hydroponic Cultivation Apparatus

In general, in one aspect, one or more non-transitory computer-readable media store instructions that, when executed by one or more processors, cause the one or more processors to perform operations including: obtaining, from multiple sensors of a hydroponic cultivation apparatus, sensor data associated with at least (a) multiple water receptacles configured to store water at different states associated with hydroponic cultivation and (b) one or more pumps configured to transport water between water receptacles in the multiple water receptacles; and controlling operation of the one or more pumps and a nutrient delivery mechanism of the hydroponic cultivation apparatus, based at least on the sensor data.

The operations may further include: transmitting the sensor data to a grow management service, via a wired communication interface and/or a wireless communication interface; and receiving instructions from the grow management service, via the wired communication interface and/or the wireless communication interface(s).

The operations may further include controlling operation of the nutrient delivery mechanism at least by controlling timing of nutrient deposits by the nutrient delivery mechanism.

The operations may further include controlling operation of the nutrient delivery mechanism at least by controlling amounts of nutrient deposits by the nutrient delivery mechanism.

The operations may further include controlling operation of the one or more pumps to obtain particular water levels in the multiple water receptacles.

The operations may further include controlling operation of the one or more pumps and the nutrient delivery mechanism based on data gathered by a grow management service from a network of hydroponic cultivation apparatuses.

The operations may further include controlling operation of at least one environmental control mechanism to modify an external environment of the hydroponic cultivation apparatus, based at least on the sensor data.

The operations may further include storing the sensor data in a data repository.

The operations may further include presenting a user interface configured to perform one or more of (a) presenting data for monitoring operation of the hydroponic cultivation apparatus or (b) receiving user input for managing operation of the hydroponic cultivation apparatus.

The operations may further include: transmitting data to a user interface presented at a user device, via a wired communication interface and/or a wireless communication interface; and receiving instructions from the user interface for managing operation of the hydroponic cultivation apparatus, via the wired communication interface and/or the wireless communication interface(s).

The operations may further include controlling operation of the one or more pumps to balance water in at least one water receptacle in the multiple water receptacles, by performing one or more of (a) adjusting a concentration of one or more nutrients in the water, (b) adjusting pH of the water or (c) adjusting total dissolved solids of substances in the water, which may be measured in parts per million (PPM). Adjusting the pH of the water may be performed without obtaining data from any sensor configured to specifically measure the pH. Adjusting the PPM of the substance in the water may be performed without obtaining data from any sensor configured to specifically measure the PPM of the substance.

The operations may further include driving power and one or more signals to one or more external peripherals.

The operations may further include controlling operation of the hydroponic cultivation device according to instructions received from a grow management service operating in a remote network.

The operations may further include transmitting data to data storage located in a remote network.

The operations may further include controlling operation of the one or more pumps so that water reaches room temperature in a fresh water receptacle in the multiple water receptacles.

The fresh water receptacle may be disposed so as to allow off-gassing of waste products while water is in the fresh water receptacle.

The operations may further include controlling operation of the nutrient delivery mechanism by depositing small amounts of nutrients periodically as a plant demands water from a fresh water receptacle in the multiple water receptacles.

The operations may further include communicating with a lighting apparatus to control light emitted by one or more light sources toward a plant. The lighting apparatus may be part of the hydroponic cultivation apparatus. The lighting apparatus may be physically coupled with the hydroponic cultivation apparatus.

### E. Instructions for Controlling Operation of a Lighting Apparatus

In general, in one aspect, one or more non-transitory computer-readable media store instructions that, when executed by one or more processors, cause performance of operations including: emitting, by one or more light sources of a lighting apparatus, light at one or more wavelengths for hydroponic cultivation; obtaining sensor data associated with a plant; and controlling operation of the one or more light sources, based at least on the sensor data.

The operations may further include: transmitting the sensor data to a grow management service, via a wired communication interface and/or a wireless communication interface; and receiving instructions usable by the controller from the grow management service, via the wired communication interface and/or the wireless communication interface(s).

The sensor data may include data associated with a status of the one or more light sources.

The sensor data may include data associated with an external environment of the lighting apparatus.

The one or more sensors may include one or more cameras, and the sensor data may include image data including one or more of still images or video.

The operations may further include: analyzing the image data to detect appearance of an object in a field of view of the one or more cameras; and initiating an anti-blinding protocol responsive to detecting the appearance of the object.

The one or more cameras may include one or more of a visible light camera, an infrared camera, or an ultraviolet illumination camera.

The operations may further include analyzing the image data to determine a status of a plant. The status of the plant may include one or more of: shape, height, and/or width of the plant over time; number of branch nodes; colors and/or sizes of eminences; leaf blemishes; motion of internal nutrient flow in the plant; an insect or other predator; mold; spores; nitrogen content of a leaf of the plant; photosynthetic efficiency of the leaves; or thermal contours of a canopy of the plant.

The operations may further include controlling operation of at least one environmental control mechanism to modify an external environment of the lighting apparatus, based at least on the sensor data.

Modifying the external environment of the lighting device may include modifying one or more of light, heat, humidity, carbon dioxide level, airflow pattern, artificial rain, or filtering odor of air near the lighting apparatus.

The operations may further include controlling a heat source and/or a dehumidifier for drying harvested plant.

The heat source and/or the dehumidifier may include one or more of the one or more light sources.

The operations may further include storing at least the sensor data in a data repository.

The operations may further include presenting a user interface configured to perform one or more of (a) presenting data for monitoring operation of the lighting apparatus or (b) receiving user input for managing operation of the lighting apparatus.

The operations may further include: transmitting data to a user interface presented at a user device, via a wired communication interface and/or a wireless communication interface; and receiving instructions from the user interface for managing operation of the lighting apparatus, via the wired communication interface and/or the wireless communication interface(s).

The operations may further include driving power and one or more signals to one or more external peripherals.

The operations may further include controlling operation of the lighting apparatus according to instructions received from a grow management service operating in a remote network.

The operations may further include transmitting data to data storage located in a remote network.

The operations may further include communicating with a hydroponic cultivation apparatus to control one or more operations of the hydroponic cultivation apparatus. The lighting apparatus may be part of the hydroponic cultivation apparatus. The lighting apparatus may be physically coupled with the hydroponic cultivation apparatus.

### F. Instructions for Modifying a Hydroponic Cultivation Process

In general, in one aspect, one or more non-transitory computer-readable media store instructions that, when executed by one or more processors, cause the one or more processors to perform operations including: receiving status data from multiple apparatuses associated with hydroponic cultivation; applying the status data to a machine learning model to determine one or more hydroponic cultivation parameters; and transmitting, to one or more apparatuses in the multiple apparatuses, one or more instructions to modify a hydroponic cultivation process according to the one or more hydroponic cultivation parameters.

The multiple apparatuses may include multiple hydroponic cultivation apparatuses.

The one or more instructions may include one or more instructions to modify operation of a water pump. The one or more instructions to modify operation of the water pump may include one or more instructions to obtain a particular water level in a water receptacle. The one or more instructions to modify operation of the water pump may include one or more instructions to balance water in a water receptacle, by performing one or more of (a) adjusting a concentration of one or more nutrients in the water, (b) adjusting pH of the water or (c) adjusting total dissolved solids of substances in the water, which may be measured in parts per million (PPM).

The one or more instructions may include one or more instructions to modify operation of a nutrient delivery mechanism. The one or more instructions to modify operation of the nutrient delivery mechanism may include one or more instructions to modify timing of nutrient deposits by the nutrient delivery mechanism. The one or more instructions to modify operation of the nutrient delivery mechanism may include one or more instructions to modify amounts of nutrient deposits by the nutrient delivery mechanism.

The multiple apparatuses may include multiple lighting apparatuses.

The one or more instructions may include one or more instructions to control operation of one or more light sources, which may include controlling an intensity of the one or more light sources.

The one or more instructions may include one or more instructions to control a heat source and/or a dehumidifier for drying harvested plant.

The multiple apparatuses may include multiple hydroponic cultivation apparatuses and multiple lighting apparatuses.

The one or more instructions may include one or more instructions to modify operation of an environmental control mechanism.

The operations may further include storing at least the status data in a data repository.

The operations may further include transmitting data to be displayed in a user interface of an apparatus in the multiple apparatuses.

The operations may further include transmitting data to be displayed in a user interface of a user device communicatively coupled with an apparatus in the multiple apparatuses.

The multiple apparatuses may be configured to perform hydroponic cultivation according to one or more recipes, the one or more instructions including one or more modifications to the one or more recipes.

The operations may further include: analyzing image data received from an apparatus in the multiple apparatuses to detect appearance of an object in a field of view of one or more cameras; and initiating an anti-blinding protocol responsive to detecting the appearance of the object.

The operations may further include analyzing image data received from an apparatus in the multiple apparatuses to determine a status of a plant.

### G. Method of Controlling Operation of a Hydroponic Cultivation Apparatus

In general, in one aspect, a method includes: obtaining, from multiple sensors of a hydroponic cultivation apparatus, sensor data associated with at least (a) multiple water receptacles configured to store water at different states associated with hydroponic cultivation and (b) one or more pumps configured to transport water between water receptacles in the multiple water receptacles; and controlling operation of the one or more pumps and a nutrient delivery mechanism of the hydroponic cultivation apparatus, based at least on the sensor data.

The method may further include: transmitting the sensor data to a grow management service, via a wired communication interface and/or a wireless communication interface; and receiving instructions from the grow management service, via the wired communication interface and/or the wireless communication interface(s).

The method may further include controlling operation of the nutrient delivery mechanism at least by controlling timing of nutrient deposits by the nutrient delivery mechanism.

The method may further include controlling operation of the nutrient delivery mechanism at least by controlling amounts of nutrient deposits by the nutrient delivery mechanism.

The method may further include controlling operation of the one or more pumps to obtain particular water levels in the multiple water receptacles.

The method may further include controlling operation of the one or more pumps and the nutrient delivery mechanism based on data gathered by a grow management service from a network of hydroponic cultivation apparatuses.

The method may further include controlling operation of at least one environmental control mechanism to modify an external environment of the hydroponic cultivation apparatus, based at least on the sensor data.

The method may further include storing the sensor data in a data repository.

The method may further include presenting a user interface configured to perform one or more of (a) presenting data for monitoring operation of the hydroponic cultivation apparatus or (b) receiving user input for managing operation of the hydroponic cultivation apparatus.

The method may further include: transmitting data to a user interface presented at a user device, via a wired communication interface and/or a wireless communication interface; and receiving instructions from the user interface for managing operation of the hydroponic cultivation apparatus, via the wired communication interface and/or the wireless communication interface(s).

The method may further include controlling operation of the one or more pumps to balance water in at least one water receptacle in the multiple water receptacles, by performing one or more of (a) adjusting a concentration of one or more nutrients in the water, (b) adjusting pH of the water or (c) adjusting total dissolved solids of substances in the water, which may be measured in parts per million (PPM). Adjusting the pH of the water may be performed without obtaining data from any sensor configured to specifically measure the pH. Adjusting the PPM of the substance in the water may be performed without obtaining data from any sensor configured to specifically measure the PPM of the substance.

The method may further include driving power and one or more signals to one or more external peripherals.

The method may further include controlling operation of the hydroponic cultivation device according to instructions received from a grow management service operating in a remote network.

The method may further include transmitting data to data storage located in a remote network.

The method may further include controlling operation of the one or more pumps so that water reaches room temperature in a fresh water receptacle in the multiple water receptacles.

The fresh water receptacle may be disposed so as to allow off-gassing of waste products while water is in the fresh water receptacle.

The method may further include controlling operation of the nutrient delivery mechanism by depositing small amounts of nutrients periodically as a plant demands water from a fresh water receptacle in the multiple water receptacles.

The method may further include communicating with a lighting apparatus to control light emitted by one or more light sources toward a plant.

The lighting apparatus may be part of the hydroponic cultivation apparatus.

The lighting apparatus may be physically coupled with the hydroponic cultivation apparatus.

### H. Method of Controlling Operation of a Lighting Apparatus

In general, in one aspect, a method includes: emitting, by one or more light sources of a lighting apparatus, light at one or more wavelengths for hydroponic cultivation; obtaining sensor data associated with a plant; and controlling operation of the one or more light sources, based at least on the sensor data.

The method may further include: transmitting the sensor data to a grow management service, via a wired communication interface and/or a wireless communication interface; and receiving instructions usable by the controller from the grow management service, via the wired communication interface and/or the wireless communication interface(s).

The sensor data may include data associated with a status of the one or more light sources.

The sensor data may include data associated with an external environment of the lighting apparatus.

The one or more sensors may include one or more cameras, and the sensor data may include image data including one or more of still images or video.

The method may further include: analyzing the image data to detect appearance of an object in a field of view of the one or more cameras; and initiating an anti-blinding protocol responsive to detecting the appearance of the object.

The one or more cameras may include one or more of a visible light camera, an infrared camera, or an ultraviolet illumination camera.

The method may further include analyzing the image data to determine a status of a plant.

The status of the plant may include one or more of: shape, height, and/or width of the plant over time; number of branch nodes; colors and/or sizes of eminences; leaf blemishes; motion of internal nutrient flow in the plant; an insect or other predator; mold; spores; nitrogen content of a leaf of the plant; photosynthetic efficiency of the leaves; or thermal contours of a canopy of the plant.

The method may further include controlling operation of at least one environmental control mechanism to modify an external environment of the lighting apparatus, based at least on the sensor data.

Modifying the external environment of the lighting device may include modifying one or more of light, heat, humidity, carbon dioxide level, airflow pattern, artificial rain, or filtering odor of air near the lighting apparatus.

The method may further include controlling a heat source and/or a dehumidifier for drying harvested plant.

The heat source and/or the dehumidifier may be one of the one or more light sources.

The method may further include storing at least the sensor data in a data repository.

The method may further include presenting a user interface configured to perform one or more of (a) presenting data for monitoring operation of the lighting apparatus or (b) receiving user input for managing operation of the lighting apparatus.

The method may further include: transmitting data to a user interface presented at a user device, via a wired communication interface and/or a wireless communication interface; and receiving instructions from the user interface for managing operation of the lighting apparatus, via the wired communication interface and/or the wireless communication interface(s).

The method may further include driving power and one or more signals to one or more external peripherals.

The method may further include controlling operation of the lighting apparatus according to instructions received from a grow management service operating in a remote network.

The method may further include transmitting data to data storage located in a remote network.

The method may further include communicating with a hydroponic cultivation apparatus to control one or more operations of the hydroponic cultivation apparatus.

The lighting apparatus may be part of the hydroponic cultivation apparatus.

The lighting apparatus may be physically coupled with the hydroponic cultivation apparatus.

### I. Method of Modifying a Hydroponic Cultivation Process

In general, in one aspect, a method includes: receiving status data from multiple apparatuses associated with hydroponic cultivation; applying the status data to a machine learning model to determine one or more hydroponic cultivation parameters; and transmitting, to one or more apparatuses in the multiple apparatuses, one or more instructions to modify a hydroponic cultivation process according to the one or more hydroponic cultivation parameters.

The multiple apparatuses may include multiple hydroponic cultivation apparatuses.

The one or more instructions may include one or more instructions to modify operation of a water pump.

The one or more instructions to modify operation of the water pump may include one or more instructions to obtain a particular water level in a water receptacle.

The one or more instructions to modify operation of the water pump may include one or more instructions to balance water in a water receptacle, by performing one or more of (a) adjusting a concentration of one or more nutrients in the water, (b) adjusting pH of the water or (c) adjusting total dissolved solids of substances in the water, which may be measured in parts per million (PPM).

The one or more instructions may include one or more instructions to modify operation of a nutrient delivery mechanism.

The one or more instructions to modify operation of the nutrient delivery mechanism may include one or more instructions to modify timing of nutrient deposits by the nutrient delivery mechanism.

The one or more instructions to modify operation of the nutrient delivery mechanism may include one or more instructions to modify amounts of nutrient deposits by the nutrient delivery mechanism.

The multiple apparatuses may include multiple lighting apparatuses.

The one or more instructions may include one or more instructions to control operation of one or more light sources, which may include controlling an intensity of the one or more light sources.

The one or more instructions may include one or more instructions to control a heat source and/or a dehumidifier for drying harvested plant.

The multiple apparatuses may include multiple hydroponic cultivation apparatuses and multiple lighting apparatuses.

The one or more instructions may include one or more instructions to modify operation of an environmental control mechanism.

The method may further include storing at least the status data in a data repository.

The method may further include transmitting data to be displayed in a user interface of an apparatus in the multiple apparatuses.

The method may further include transmitting data to be displayed in a user interface of a user device communicatively coupled with an apparatus in the multiple apparatuses.

The multiple apparatuses may be configured to perform hydroponic cultivation according to one or more recipes, the one or more instructions including one or more modifications to the one or more recipes.

The method may further include: analyzing image data received from an apparatus in the multiple apparatuses to detect appearance of an object in a field of view of one or more cameras; and initiating an anti-blinding protocol responsive to detecting the appearance of the object.

The method may further include analyzing image data received from an apparatus in the multiple apparatuses to determine a status of a plant.

### BRIEF DESCRIPTION OF THE DRAWINGS

Various aspects of at least one embodiment are discussed below with reference to the accompanying Figures, which are not intended to be drawn to scale. The Figures are included to provide illustration and a further understanding of the various aspects and embodiments, and are incorporated in and constitute a part of this specification, but are not intended to define the limits of the disclosure. In the Figures, each identical or nearly identical component that is illustrated in various Figures is represented by a like numeral. For the purposes of clarity, some components may not be labeled in every figure. In the Figures:

FIGS. 1A and 1B are block diagrams of cross-sectional views of configurations of hydroponic cultivation apparatuses (also referred to herein as grow-bots) according to an embodiment;

FIGS. 2A-2B are block diagrams of an example of a system according to an embodiment;

FIGS. 3A-3E show different views of an example of a grow-bot according to an embodiment;

FIG. 4 shows charts of demand for home cannabis growing by populations;

FIGS. 5A-5D illustrate examples of a light-bot according to an embodiment;

FIGS. 6A-6N show diagrams of examples of a nutrient cartridge according to an embodiment; and

FIG. 7 is a block diagram of an example of a computer system according to an embodiment.

### DETAILED DESCRIPTION

One or more embodiments include techniques for growing plants (including but not limited to cannabis) in a deep water culture (DWC) environment using a system of two or more containers. An automated DWC system feeds fresh water from a water container and nutrients from a nutrient cartridge to a primary growth container and remove waste water to a waste container. The DWC system may include devices in multiple locations and/or associated with different users. The DWC system may include a control system that adapts automatically to various challenges experienced by users in the support of their plants' growth cycles. One or more of the devices may be configured to determine which operations the DWC system should perform and instruct the corresponding system component(s) to execute those operations. For example, the device(s) may instruct one or more components of the DWC system to perform operations that maintain the right level of nutrients and the right pH throughout a growth cycle. Such a system may reduce or eliminate the need for expensive sensors and/or allow for the use of common tap water as a base grow medium.

Some examples described herein include machine learning techniques, sometimes referred to as “artificial intelligence” (AI). In an embodiment, machine learning allows the DWC system to tune the decision-making process based on data from past experiences, resulting in further improved growth outcomes. A machine learning model may be trained on data from past experiences and may continue to learn based on data gathered on an ongoing basis. Thus, the DWC system may produce healthier plants sooner—even for inexperienced users—by sharing the collected experience of devices throughout the system.

In an embodiment, a distributed network of hydroponic growing apparatuses (e.g., grow-bots and/or light-bots as described herein) collect data such as what they are growing, what the immediate environment look like, etc. Users may also provide subjective input via a user interface. The data may be aggregated by a growth management service (e.g., in the cloud) along with other relevant data such as average water composition by zip code, average environmental data by zip code, historical data from multiple users, and base recipe information, etc. The growth management service may use the data to further optimize the recipes and may relay the information back to the distributed network of hydroponic growing apparatuses.

### A. System Architecture

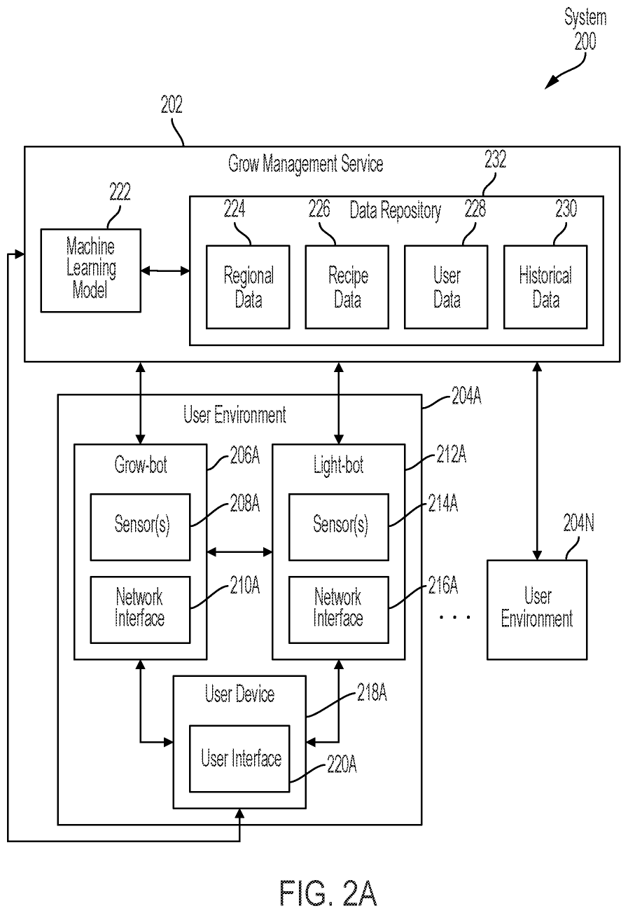

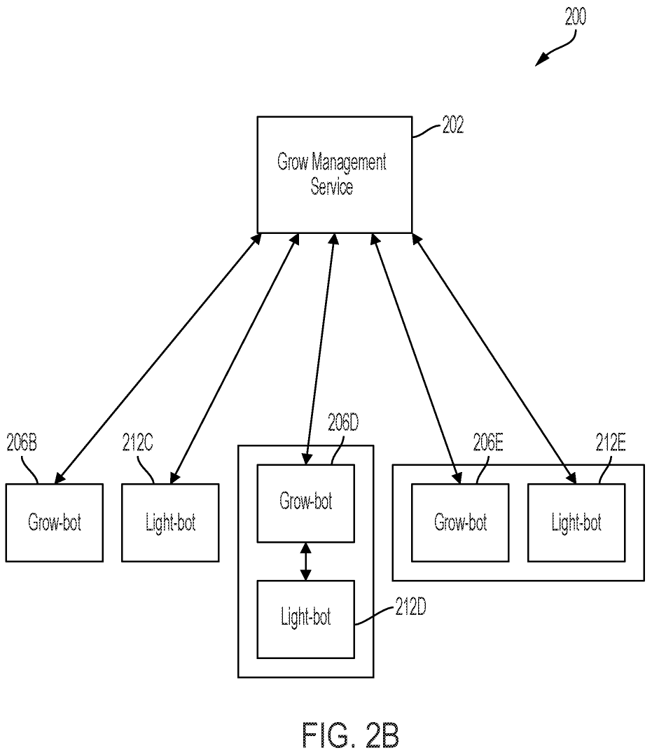

FIGS. 2A-2B are a block diagram of an example of a system 200 according to an embodiment. In an embodiment, the system 200 may include more or fewer components than the components illustrated in FIGS. 2A-2B. The components illustrated in FIGS. 2A-2B may be local to or remote from each other. The components illustrated in FIGS. 2A-2B may be implemented in software and/or hardware. Each component may be distributed over multiple applications and/or machines. Multiple components may be combined into one application and/or machine. Operations described with respect to one component may instead be performed by another component.

As illustrated in FIG. 2A, the system includes a grow management service 202 and one or more user environments 204A, 204N. Each user environment 204A, 204N refers to a distinct physical location. For example, two or more user environments 204A, 204N may be in different buildings (e.g., homes, offices, etc.). Alternatively or additionally, two or more user environments 204A, 204N may be in different locations in the same building (e.g., in different rooms and/or different locations in the same room).

A user environment 204 may include a growing device 206A, also referred to herein as a “grow-bot.” Alternatively or additionally, a user environment 204A may include a light device 212A, also referred to herein as a “light-bot.” A grow-bot 206A and/or light-bot 212A may be configured to perform operations to grow a plant disposed in the grow-bot 206A. One or more operations performed by a grow-bot 206A and/or light-bot 212A may be dictated by a recipe as described herein, which may be supplied by the grow management service 212. In some embodiments, based on the results of machine learning, the grow management service 212 periodically provides recipe updates to the grow-bot 206A and/or light-bot 212A.

A grow-bot 206A is a hydroponic growing device (e.g., for cannabis) that may be controlled at least in part by the grow management service 202. A grow-bot 206A may be configured to perform one or more of: providing grow media and mechanical stability for the plant; provide recipe-controlled, time-varying nutrients to the grow media and thereby to the plant; monitoring and detecting current system and plant conditions; analyzing time series data from images or video of the current environment (e.g., for anti-blinding control as discussed herein); using one or more sensors 208A to continuously collect data from the environment around the grow-bot 208A; and/or sending data (e.g., sensor data, analysis results, and/or other data) to the grow management service 202. A grow-bot 206A may be configured to receive light from a light-bot 212A and/or from another light source.

A light-bot 212A may be configured to provide one or more light sources for a grow-bot 206A and/or another kind of growing device. In addition, the light-bot 212A may be configured to perform one or more of: monitoring and detecting current system and plant conditions (e.g., detecting a leak); using one or more sensors 214A to obtain images and/or video of the current plant condition (e.g., using a still or video camera); influencing the air environment near the plant, such as light, heat, humidity, carbon dioxide levels, airflow patterns, artificial rain, filtering odors, and/or other air environment properties; analyzing time series data from images or video of the current environment (e.g., for anti-blinding control as discussed herein); drying harvested plant (e.g., cannabis) by controlling air, light, and heat parameters, which may include odor control during the drying process; and/or using one or more sensors 214A to continuously collect data from the environment around the light-bot 212A.

In an embodiment, a grow-bot 206A and a light-bot 212A are supplied by the same manufacturer and may be designed as companion devices having complementary functions. The grow-bot 206A, light-bot 212A, and grow management service 202 may be components of a connected system configured to make plant growing a simple, consumer-friendly operation. D Different user environments 204A, 204N may include different configurations of grow-bots, light-bots, other growing environments, and/or other light sources.

A grow-bot 206A and a light-bot 212A each may include respective network interfaces 210A, 216A that allow the devices to communicate with other devices over Ethernet, Wi-Fi, Bluetooth, Zigbee, etc. The grow-bot 206A and light-bot 212A each may be configured to communicate with the grow management service 202, for example, over an Internet connection. Alternatively or additionally, the grow-bot 206A and light-bot 212A may be configured to communicate with each other, for example, over local network in the user environment 204A that both of the devices have joined. In some embodiments, the grow-bot 206A may be configured to communicate with the grow management service 202 over the Internet and with the light-bot 212A over a local connection (e.g., a local Wi-Fi network, Bluetooth, etc.).

FIG. 2B is a block diagram of examples of different configurations of the system 200 according to an embodiment. Specifically, FIG. 2B includes the following example configurations:
1. A grow-bot 206B operating without a light-bot and configured to communicate with the grow management service 202.
2. A light-bot 212C operating without a grow-bot and configured to communicate with the grow management service 202.
3. A grow-bot 206D and light-bot 212D operating in the same user environment and configured to communicate with each other, but only the grow-bot 206D is configured to communicate with the grow management service 202.
4. A grow-bot 206D and light-bot 212E operating in the same user environment and both configured to communicate with the grow management service 202.

In some embodiments, the grow-bot 206B and light-bot 212B may be physically connected to each other, for example as a single unit or units that are configured to attach to each other, but not configured to communicate with each other. Alternatively, one device (for example, the grow-bot) may be configured to supply power, data, and operational instructions to the other device (for example, the light-bot), for example using one or more power and/or data ports (e.g., a universal serial bus (USB) connection or other kind of data port).

In some embodiments, a grow-bot does not physically support the light-bot. A light-bot may physically enclose a grow-bot or be suspended over the grow-bot (for example, on three or more legs). One device (for example, the grow-bot) may be configured to supply power, data, and operational instructions to the other device (for example, the light-bot), for example using one or more power and/or data ports (e.g., a universal serial bus (USB) connection or other kind of data port).

In some embodiments, a light-bot does not obtain power, data, or operational instructions from a grow-bot, but is configured to communicate directly with the grow management system 202 as described herein.

Returning to FIG. 2A, in an embodiment, a grow management service 202 includes a data repository 232 configured to store data used to control grow-bots and/or light-bots in the user environments 204A, 204N. A data repository 232 may include any type of storage unit and/or device (e.g., a file system, database, collection of tables, or any other storage mechanism) for storing data. A data repository 232 may include multiple different storage units and/or devices. The multiple different storage units and/or devices may or may not be of the same type or located at the same physical site. Further, a data repository 232 may be implemented or may execute on the same computing system as one or more other components of the system 200. A data repository 232 may be implemented or executed on a computing system separate from one or more other components of the system 200. A data repository 232 may be logically integrated with one or more other components of the system 200. A data repository 232 may be communicatively coupled to one or more other components of the system 200 via a direct connection or via a network. In FIG. 2A, a data repository 232 is illustrated as storing various kinds of information. Some or all of this information may be implemented and/or distributed across any of the components of the system 200. However, this information is illustrated within the data repository 232 for purposes of clarity and explanation.

Data stored in the data repository 232 may include one or more of:
1. Regional data 224 such as average water composition, atmospheric conditions, etc. for different regions (e.g., counties, cities, zip codes, countries, altitudes, etc.) in which the user environments 204A, 204N may be located. To obtain regional data 224, the grow management service 202 may be configured to access one or more third-party services (not shown) such as a weather service, water quality tracking system, and/or other third-party service that provides data relevant to plant growth in a particular region.
2. Recipe data 226 including base grow recipes for one or more plant types and/or strains thereof. As used herein, the term “recipe” refers to a set of instructions for growing a plant. For example, a recipe may include one or more data structures including a schedule of lighting, nutrient dosage, and environmental parameters designed to promote plant growth. grow-bots and/or light-bots may be configured to execute operations corresponding to elements of the recipe. The grow management service 202 may be configured to modify recipes (e.g., at a global level and/or at the individual user level) using machine learning as described herein. Alternatively or additionally, the system 200 may be configured to receive user input to reconfigure one or more elements of a recipe and generate a user-customized recipe based on the user input.
3. User data 228 including user device profiles (e.g., models and configuration details of grow-bots, light-bots, and/or other devices used in the different user environments 204A, 204N), locations, plant strain(s) being grown, subscription data, etc.
4. Historical data 230 including data gathered from grow-bot sensors 208A and/or light-bot sensors 214A, providing a history of actual grow conditions in the user environments 204A, 204N. Historical data 230 may also include user-supplied data such as subjective evaluations of plant quality, user experience feedback, etc.

To control the operation of grow-bots and/or light-bots in the user environments 204A, 204N, the grow management service 202 may be configured to train a machine learning model 222 using data from the data repository 232. Machine learning is discussed in further detail below. In general, machine learning allows the grow management service 202 to learn from past experiences, to better control other devices in the system 200 for improved growth outcomes. For example, the grow management service 202 may continuously store data from one or more grow-bots 206A, 206N and/or light-bots 212A, 212N and use machine learning to analyze the data. Based on the results of machine learning, the grow management service 202 may be configured to send user- and/or plant-specific recipes to one or more grow-bots 206A, 206N and/or light-bots 212A, 212N.

Alternatively or additionally, the grow management service 202 may be configured to execute heuristic recipe algorithms for adjusting recipes according to specific user preferences, environmental conditions, device configurations, seed and/or plant types, etc. The grow management service 202 may be configured to execute heuristic algorithms to adjust recipes based on data continually provided by one or more grow-bots 206A, 206N and/or light-bots 212A, 212N.

The grow management service 202 may be configured to continuously receive diagnostic data from one or more grow-bots 206A, 206N and/or light-bots 212A, 212N. The grow management service 202 may be configured to analyze the diagnostic data (e.g., using machine learning). Based on the results of analyzing the diagnostic data, the grow management service 202 may be configured to determine the status of each individual unit for maintenance and support, and/or generate one or more alerts when user intervention is needed with respect to a unit.

The grow management service 202 may be configured to provide data to one or more user interfaces, such as the user interface 220A of user device 218A. Such data may include, for example, reports (e.g., regarding plant and/or device statuses, which may include monitoring limits with respect to light, odor, power usage, etc.), alerts, etc.

In some embodiments, one or more operations described herein as being performed by a grow management service 202 may be performed by a grow-bot 206A and/or light-bot 212A. For example, a grow-bot 206A may be configured to perform machine learning for an individual user, within the user environment 204A and/or in communication with other devices in the same local network.

In an embodiment, the system 200 allows for tap water to be used in DWC hydroponics, gassing out chemicals and applying the right nutrient quantities to water, while maintaining a base level of pH. The grow-bot 206A's main water tank has the active water for an initial period of time and will activate pumps to remove this water at a specified time, moving water to a waste water tank. Fresh water then goes into the water tank. The system 200 may help maintain the water level in the main water tank, to help compensate for water consumed by the plant. This approach helps maintain the right growing conditions—such as the base pH, the right nutrients, and oxygenating the roots. The grow-bot 206A may operate based on a scheduled delivery of nutrients, which may be generated by machine learning operations performed by the grow management service 202.

In an embodiment, a system 200 such as that illustrated in FIGS. 2A-2B simplifies maintenance efforts throughout a growth cycle in a DWC environment, while minimizing user interaction. Information from the growth cycle may be into an algorithm that learns from the available data, adjusts device behavior, and optimizes plant health for each automatically. Because user environments 204A, 204N do not need to be physically collocated, data can be collected in parallel from multiple sources. Collecting data from multiple sources increases the robustness of the data set feeding machine learning, while simplifying the user experience. This data can be applied to any machine in the system 200, regardless of form factor or location. Because user effort is reduced, the barrier to entry is as well. This means that inexperienced users can contribute to the system 200, with improved initial results, leading to a virtuous cycle and increased usership.

A user environment 204A may include one or more user devices 218A, such as a smartphone, tablet, laptop computer, desktop computer, special-purpose computing device, or other kind of device having a user interface 220A. A user device 218A may be configured to present information about the plant(s) growing in the user environment 204A in the user interface 220. For example, the user device 218A may be configured to obtain reports from the growth management service 202, with information about the plant(s) growth progress. Because the growth management service 202 has access to information from multiple user environments 204A, the reports may include comparative data, such as how well a plant is performing relative to average expectations, other plants in the same geographic region, etc. Alternatively or additionally, a user device 218A may be configured to communicate directly (e.g., over a local network) with a grow-bot 206A and/or light-bot 212A, to obtain grow information and/or control operation of those device(s). For example, the user device 218A may include instructions for shutting off the grow-bot 206A and/or light-bot 212A, and/or controlling other physical functions of the device(s). Reporting and other functionality may be accessible in the user device 218A via user-installed software such as an application or “app.” Alternatively or additionally, the user interface 220A may be a web browser configured to access one or more web pages generated by the growth management service 202.

In general, a user interface 220A refers to hardware and/or software configured to facilitate communications between a user and a user device 218A. A user interface 220A renders user interface elements and receives input via user interface elements. A user interface 220A may be a graphical user interface (GUI), a command line interface (CLI), a haptic interface, a voice command interface, and/or any other kind of interface or combination thereof. Examples of user interface elements include checkboxes, radio buttons, dropdown lists, list boxes, buttons, toggles, text fields, date and time selectors, command lines, sliders, pages, and forms. Different components of a user interface 220A may be specified in different languages. The behavior of user interface elements may be specified in a dynamic programming language, such as JavaScript. The content of user interface elements may be specified in a markup language, such as hypertext markup language (HTML), Extensible Markup Language (XML), or XML User Interface Language (XUL). The layout of user interface elements may be specified in a style sheet language, such as Cascading Style Sheets (CSS). Alternatively or additionally, aspects of a user interface 220A may be specified in one or more other languages, such as Java, Python, Perl, C, C++, and/or any other language or combination thereof.

One or more components of the system 200 may be implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware network address translator (NAT), a hardware load balancer, a mainframe, a television, a content receiver, a set-top box, a printer, a mobile handset, a smartphone, a personal digital assistant (“PDA”), a wireless receiver and/or transmitter, a base station, a communication management device, a router, a switch, a controller, an access point, and/or a client device.

### B. Example Grow-Bots

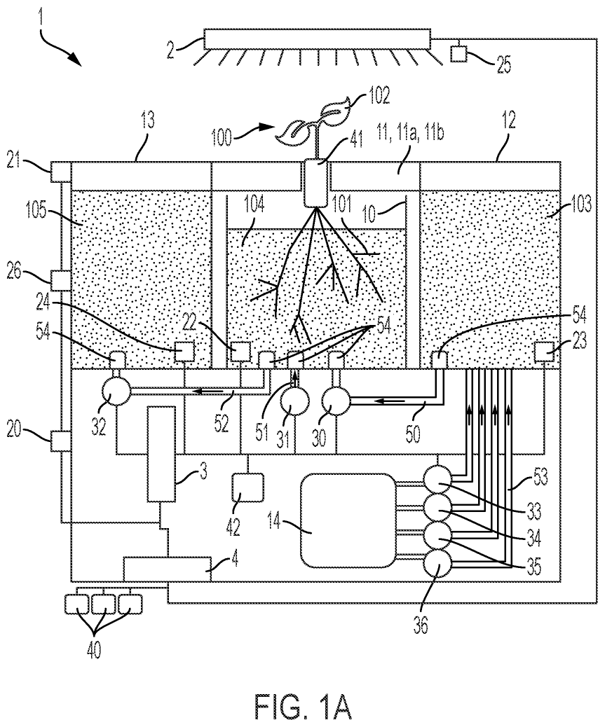

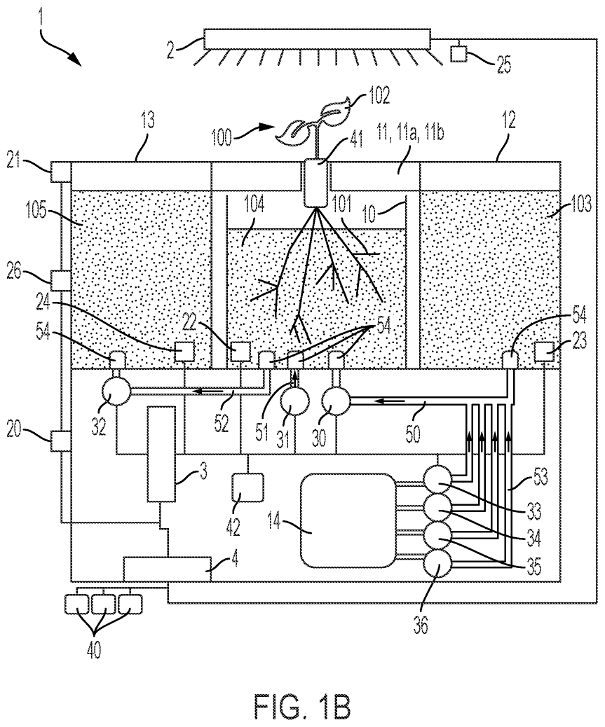

FIGS. 1A and 1B are block diagrams of cross-sectional views of configurations of hydroponic cultivation apparatuses (also referred to herein as grow-bots) according to an embodiment. The examples shown in FIGS. 1A-1B are provided for illustrative purposes only and should not be construed as limiting one or more embodiments.

In an embodiment, a hydroponic cultivation apparatus 1 is configured to perform hydroponics for growing a plant body 100 without using soil. The hydroponic cultivation apparatus 1 cultivates the plant body 100 by supplying a liquid to roots 101. The hydroponic cultivation apparatus 1 includes a structure to supply a liquid to the plant body 100. Here, the liquid includes water, and a culture solution prepared by adding nutrients to water.

The hydroponic cultivation apparatus 1 grows the plant body 100 that has roots 101. The hydroponic cultivation apparatus 1 includes a main grow bucket 10 with support section 11, a fresh water bucket 12 for storing fresh water 103 and mixing nutrients from a nutrient cartridge 14 by way of a peristaltic pump system (33, 34, 35, 36), a waste water bucket 13 for storing used water 105 from the main grow bucket 10 on a set schedule, an array of sensors (20, 21, 22, 23, 24, 25), several pumps (30, 31, 32, 33, 34, 35, 36), a controller 3, and controlled power outlets 4.

The hydroponic cultivation apparatus 1 includes a support section 11 that supports the plant body 100. The support section includes a lid 11a for example and a penetrated portion 11b. The support section supports plant carrier(s) 41 which in turn support the roots 101 of the plant body 100. Here, the lid portion 11a may be provided with one or more penetrated portions 11b.

Of the plant body 100 supported by the support section 11, the stem and leaves 102 are also supported and grow toward the direction of the light source 2, which in this example is above the plant. The stem and leaves 102 can perform photosynthesis by receiving light emitted from the light source 2.

The support section 11 is above the main grow bucket 10. The support section 11 supports the roots 101 of the plant body 100 with the penetrated portion 11b. In this way, the hydroponic cultivation apparatus 1 defines an area for growth while establishing a sufficiently sealed state for storing water with nutrients 104 and not promoting the growth of invasive organisms such as algae.

The main grow bucket 10 is attached to the main body through one or multiple quick release mechanisms 54 that connect it to various pumps (30, 31, 32) in the system for water inflow, outflow, and air inflow. The quick release mechanisms 54 create a sufficient water and air seal and allows for the main grow bucket 10 to be removed and washed pre- and post-growth, for example. Other examples may utilize an integrated main grow bucket 10 as a part of the main body. Such an approach would not require quick release mechanisms 54 and could instead rely upon simpler plumbing connections.

The main grow bucket 10 uses a water level sensor 22 to understand how much water with nutrients it has 104. The information from the water level sensor 22 can be used to know when the main grow bucket 10 is in a full state, empty state, or somewhere in between. The water level sensor 22 relays this information to the controller 3 as input for decision making. During an active growth cycle, the controller 3 may use the information from the water level sensor 22 to continuously try and keep the water with nutrients 104 inside of the main grow bucket 10 at a full state by drawing fresh water 103 that may or may not contain nutrients from the fresh water bucket 12 by way of a pump 30 that the controller can control for example. During a water replacement cycle, the controller 3 may use the information from the water level sensor 22 to determine if there is water in the main grow bucket 10 and choose to drain the water with nutrients 104 from the main grow bucket 10 to the waste water bucket 13 by way of a pump 32 until the main grow bucket 10 is in an empty state, for example.

The main grow bucket 10 is also connected to an air pump 31 that can be controlled by the controller 3 to provide oxygen to the water with nutrients 104 inside of the main grow bucket 10, for example. The waste water bucket 13 is connected to the main hydroponic cultivation apparatus 1 by way of a quick release mechanism 54 for easy removal and attachment and so it can be cleaned and waste water 105 can be disposed of easily, for example. The waste water bucket 13 is in close proximity to a water level sensor 24 to assist in determination of water 105 level. The controller 3 uses information from the water level sensor 24 to inform the user of the water level and to use it as input for when to run the pump 32 to drain the main grow bucket 10, for example.

The fresh water bucket 12 is connected to the main hydroponic cultivation apparatus 1 by way of a quick release mechanism 54 for easy removal and attachment and so it can be cleaned and fresh water 103 can be added easily, for example. A functionally equivalent system could utilize an integrated fresh water bucket 12 as a part of the main body. Such an approach would not require quick release mechanisms 54 and could instead rely upon simpler plumbing connections. The fresh water bucket 12 is in close proximity to a water level sensor 23 to assist in determination of water 103 level. The controller 3 uses information from the water level sensor 23 to inform the user of the water level and to use it as input for when to run the pump 30 to add water into the main grow bucket 10, nutrients from the nutrient cartridge 14 by way of peristaltic pumps (33, 34, 35, 36), for example.

The pumps (30, 31, 32, 33, 34, 35, 36) are all plumbed with appropriate channels or tubing (50, 51, 52, 53) that create an appropriate seal for water and/or air.

The nutrient cartridge 14 is easily accessible, attached, and detached from the hydroponic cultivation apparatus 1 and contains and excess of nutrients for a single grow, for example. This cartridge interfaces with the peristaltic pumps (33, 34, 35, 36) that are controlled by the controller 3 and administer a specific amount of nutrients to the fresh water bucket 12 on a schedule, for example.

The controller 3 carries out the control for cultivating the plant body 100 with the hydroponic cultivation apparatus 1. The controller 3 may be a control device attached to the hydroponic cultivation apparatus 1, for example. Meanwhile, the controller may be a personal computer, a mobile terminal, and the like owned by the user. Furthermore, the controller 3 may be connected not only to the single hydroponic cultivation apparatus 1 and the single light source 2, but also to multiple hydroponic cultivation apparatuses 1, light sources 2, and central database repository that is in a remote location.

The controller 3 stores data, which represents the historical and actual readings from the temperature and humidity sensor 20, the input button 26, the light sensor 21, the light distance sensor 25, the nutrients dispensed by the pumps (33, 34, 35, 36), the water levels from the respective sensors (22, 23, 24), the type of plant the hydroponic cultivation apparatus 1 is growing, the time of growth, the recipe and any adjustments to it, for example. Accordingly, the controller 3 causes the pumps (30, 31, 32, 33, 34, 35, 36) to pump, the LEDs 26 to change color, the controlled power outlets 4 to turn on the light 2 and other connected devices 40, and the internal to external pump and valve options 42 to engage, based on recipes and timed measurements by a not-illustrated timer. Thus, the controller 3 can cycle the machine in ways that assist the plant 100 growth automatically and without needing additional sensing equipment to keep water PH and PPM in balance for the fresh water 103 and the main water with nutrients 105.

The internal to external pump and valve options 42 may be used to obviate the need for a waste water bucket 13 and the need for the user to remove the fresh water bucket 12 to fill with water. The internal to external pump and valve options 42 connect to the fresh to main water tubing 50 in order to fill the fresh water bucket 12 with water and also connect to the drain water tubing 52 in order to dispose the waste water 105 outside of the machine instead of in the waste water bucket 13.

The controlled power outlets 4 can be used to control attached accessories 40 on timers and according to a recipe in order to help with the amount of time a light 2 source is turned on, the intensity of the light, and to help with keeping the environment consistent with the needs of the plant 100 by adjusting the temperature, humidity, or air flow through connected external devices, for example.

In other examples (not shown), the pump 30 may connect to the fresh water tank (12) and then to a connection between pumps 33-36 (the nutrients) and the grow tank (10).

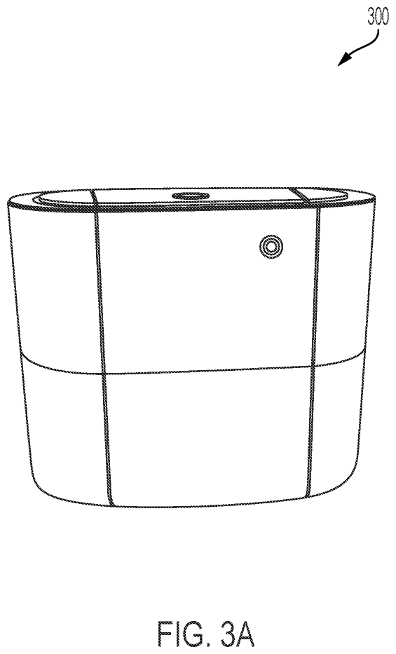

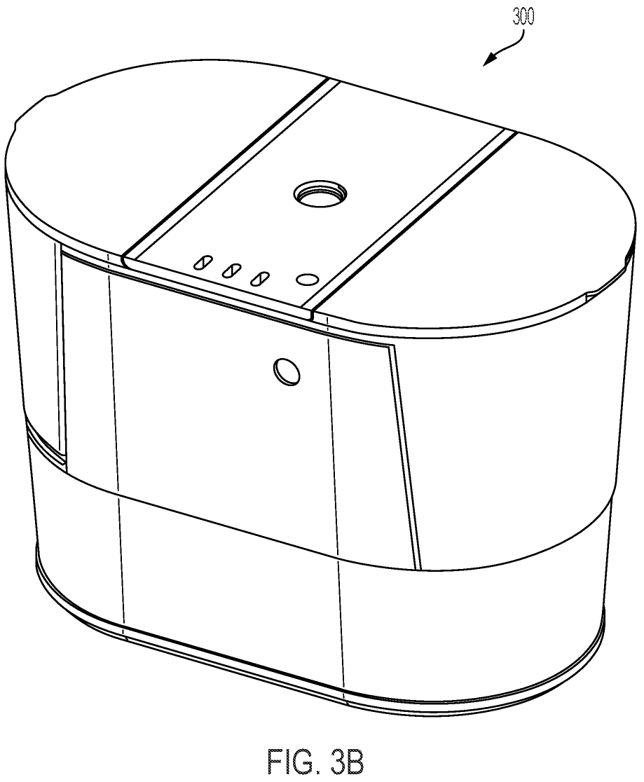

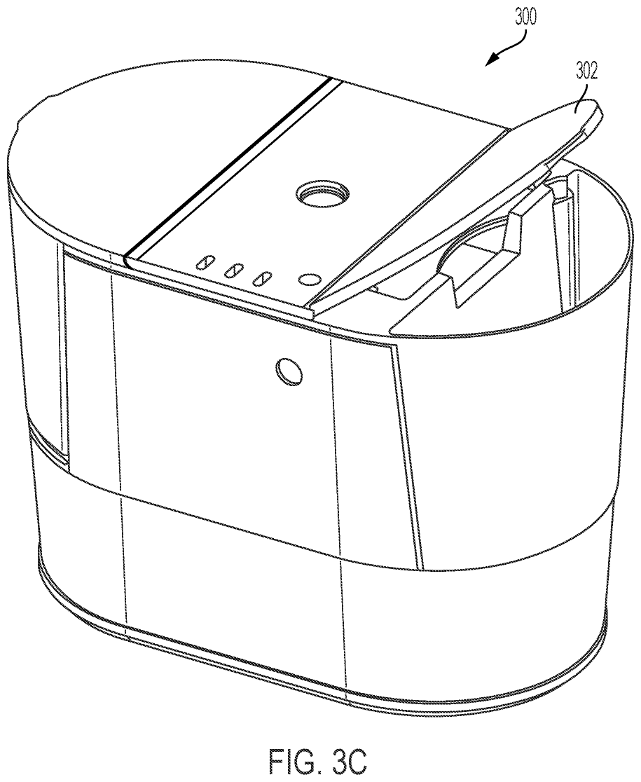

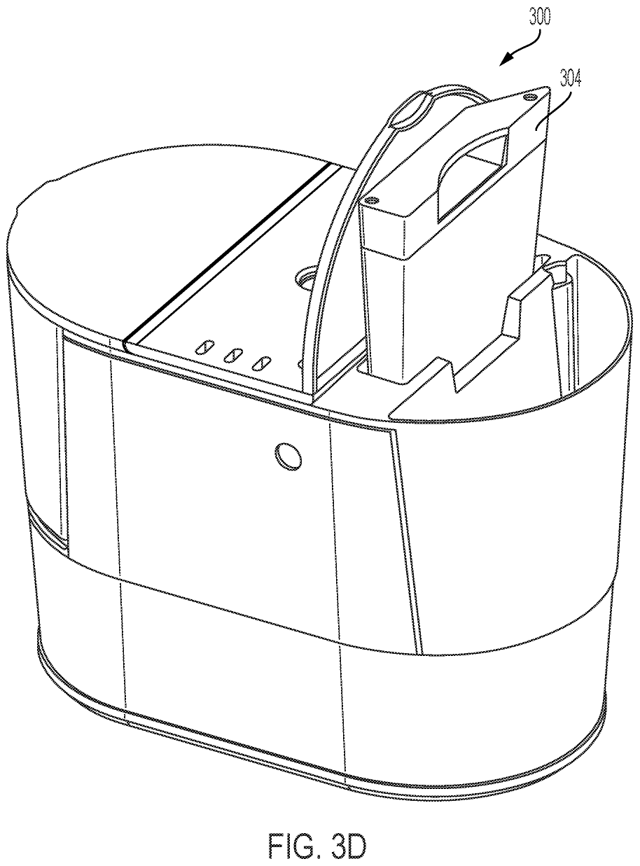

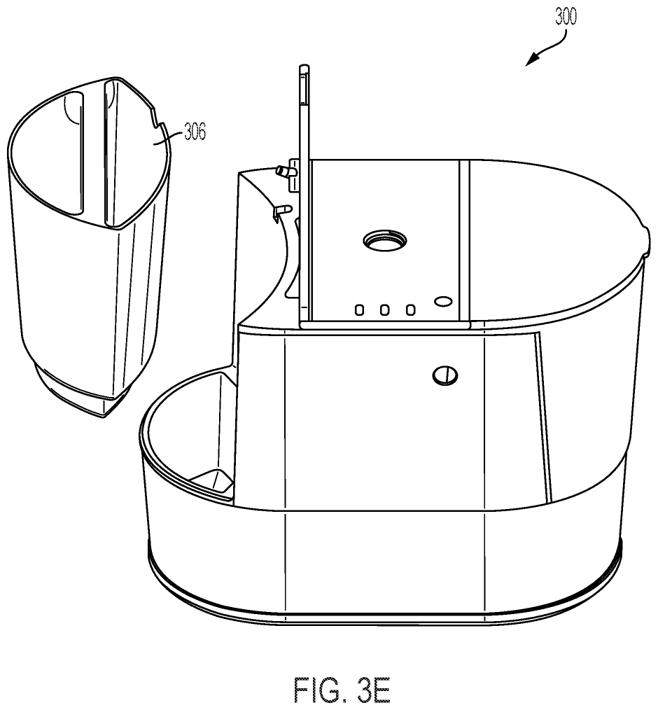

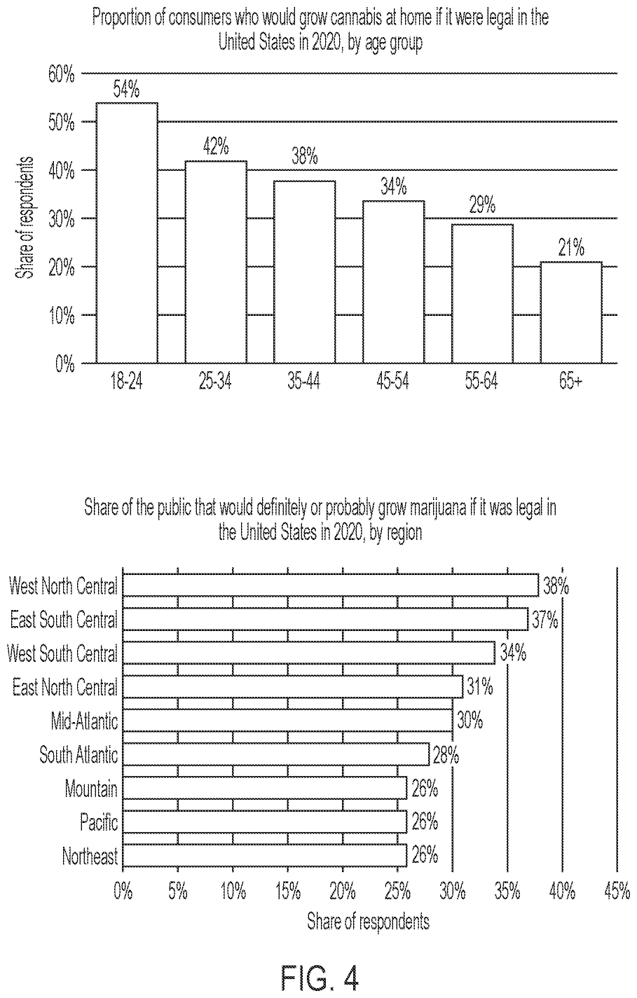

FIGS. 3A-3E show different views of an example of a grow-bot according to an embodiment. The examples shown in FIGS. 3A-3E are provided for illustrative purposes only and should not be construed as limiting one or more embodiments.

Specifically, FIG. 3A shows a photograph of a design for a grow-bot as viewed from the front, according to an embodiment. FIG. 3B illustrates a perspective view of the grow-bot of FIG. 3A as viewed from the front. FIG. 3C illustrates another perspective view of the grow-bot of FIG. 3A as viewed from the front, with the fresh water bucket cover 302 partially open. FIG. 3D illustrates another perspective view of the grow-bot of FIG. 3A as viewed from the front, with the nutrient cartridge 304 partially inserted. FIG. 3E illustrates another perspective view of the grow-bot of FIG. 3A as viewed from the front, with the waste water bucket 306 removed.

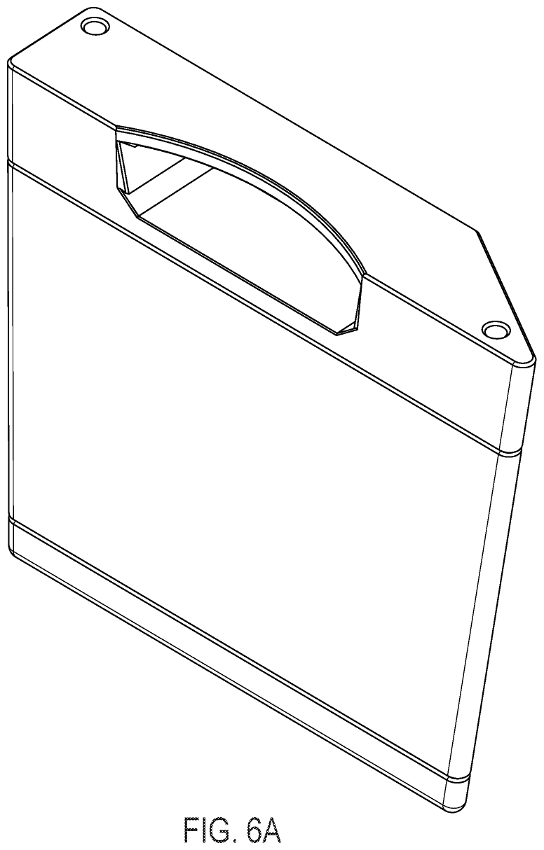

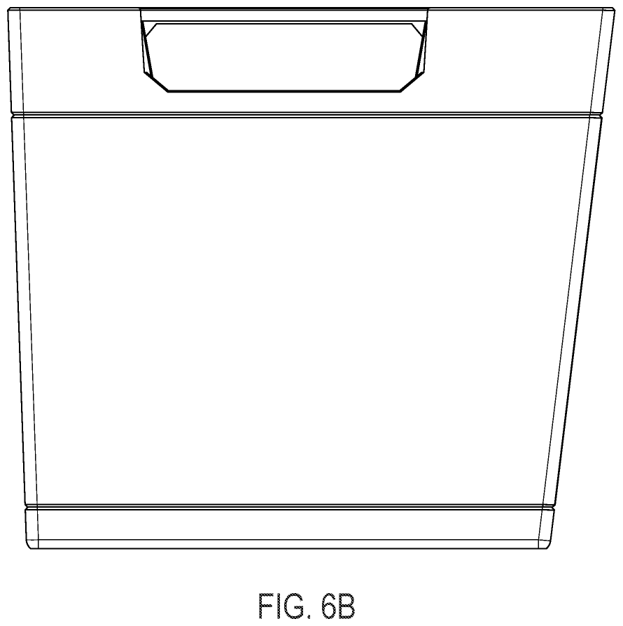

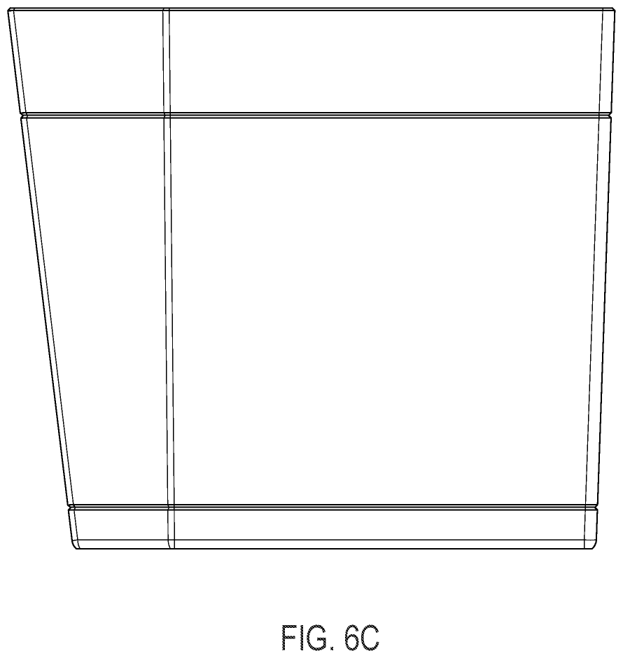

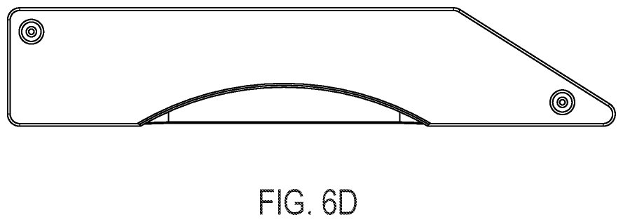

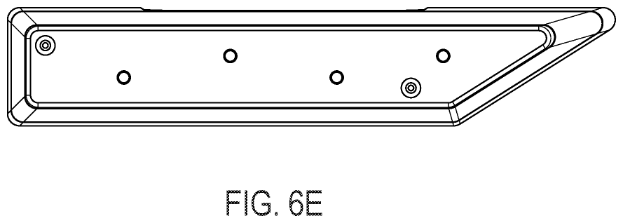

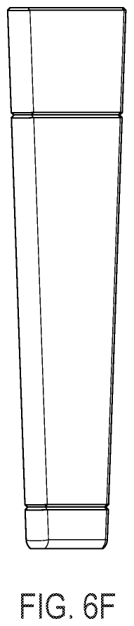

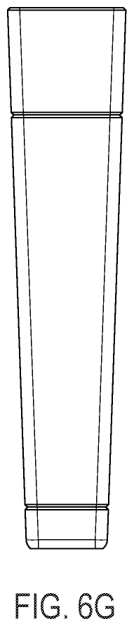

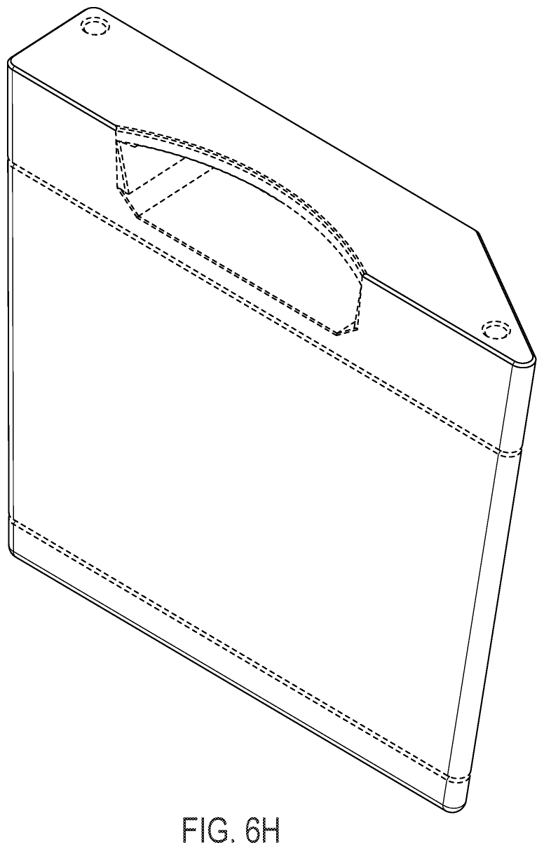

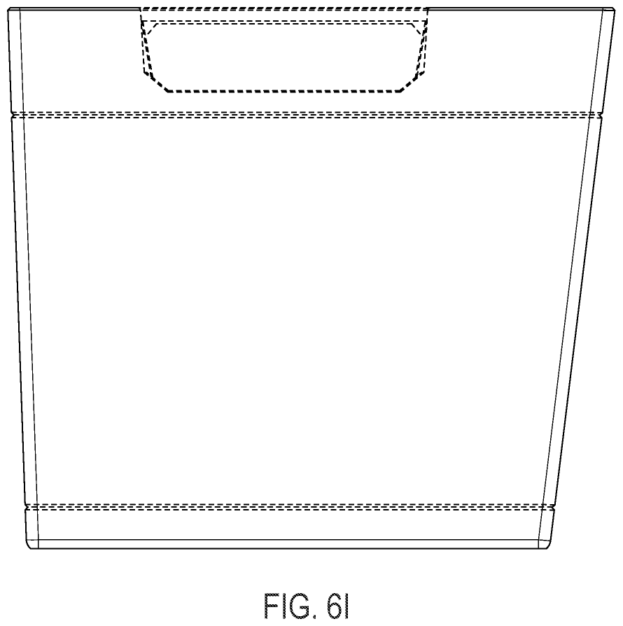

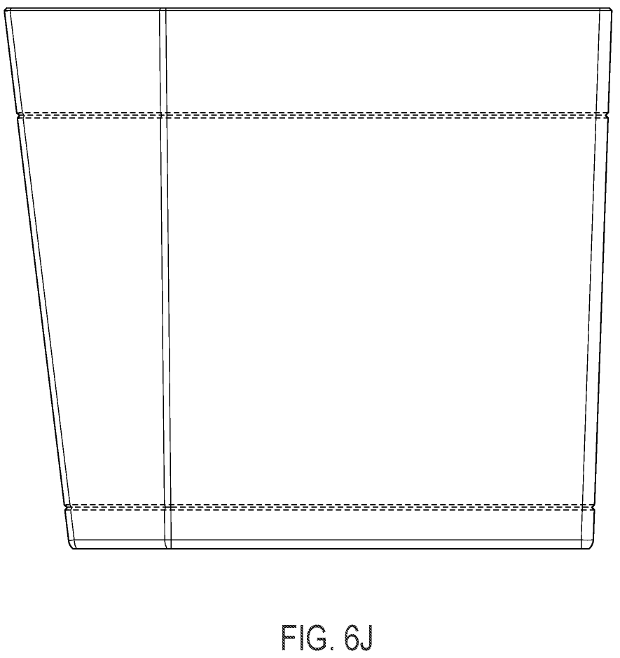

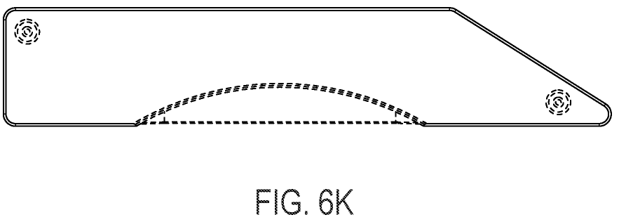

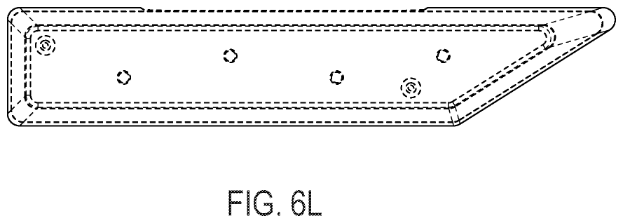

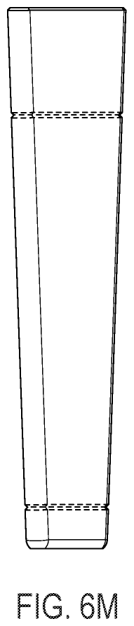

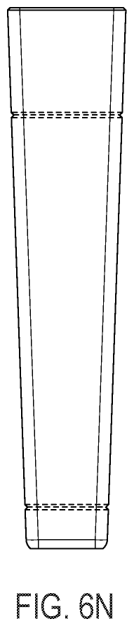

FIGS. 6A-6N shows diagrams of examples of a nutrient cartridge according to an embodiment. These examples are provided for illustrative purposes only and should not be construed as limiting one or more embodiments. Specifically, FIG. 6A is an upper and front perspective view of a nutrient cartridge according to an embodiment; FIG. 6B is a front view thereof; FIG. 6C is a rear view thereof; FIG. 6D is a top view thereof; FIG. 6E is a bottom view thereof; FIG. 6F is a right side view thereof; and FIG. 6G is a left side view thereof. FIG. 6H is an upper perspective view of a nutrient cartridge according to another embodiment; FIG. 6I is a front view thereof; FIG. 6J is a rear view thereof; FIG. 6K is a top view thereof; FIG. 6L is a bottom view thereof; FIG. 6M is a right side view thereof; and FIG. 6N is a left side view thereof.

### C. Example Light-Bots

As noted above, a hydroponics system may include one or more light-bots, i.e., light devices configured to provide light to a plant and adjust various environmental factors according to a recipe. A light-bot may include one or more light sources, which may include one or more of high pressure sodium (HPS), metal halide (MH), ceramic metal halide (CMH), light-emitting diode (LED), chip-on-board (COB) LED, and/or another kind of light. Two or more light sources (e.g., two or more COB LEDs) may be used to provide recipe-controlled spectral variations—for example, to differentiate between germination, vegetation, and flower phases of growth.

A light-bot may be configured to physically focus a light field on the plant, using reflectors and/or optical (e.g., glass) lenses.

A light-bot may be configured to control one or more light sources using a variable-brightness power supply, which may be controlled according to a recipe. This approach allows for varying the spectrum of the light during the grow cycle (e.g., according to the recipe) and simulating natural seasonal light variations. In addition, physically separating two or more light sources allows for simulating the natural sunrise/sunset daily cycle, which may help increase plant strength.

A light-bot may include one or more passive and/or active heat sink elements and may be configured to cool a light source using the heat sink element(s).

A light-bot may include a current divider that allows a single controlled fixed-current power supply to drive multiple light sources in varying intensities.

A light-bot may include one or more cameras. The light-bot may be configured to use the camera(s) to obtain a series of images (for example, at set intervals such as 10 per second or once per 30 minutes, which may be configurable) that provide time-ordered snapshots of plant growth. The light-bot and/or a growth management service may be configured to analyze the image series (e.g., using machine learning) to assist with nutrient and environmental control recipes. The light-bot and/or growth management service may be configured to combine the image series in time sequence order, to generate a “grow video” that can be delivered to a customer (e.g., via web or application on a user device).

A camera included in a light-bot or grow-bot may provide a safety measure to avoid blinding a person or other creature with bright light. The light-bot or grow-bot may be configured to detect motion within the camera's field of view. The camera may be configured so that the field of view goes beyond the predicted range of possible plant volume. If motion not related to the plant is detected, the light-bot or grow-bot may immediately reduce the light-bot's light intensity below a predetermined blinding threshold level. When the moving object (e.g., dog, person, cat, vacuum cleaner, etc.) leaves the camera's field of view, the light-bot's light intensity may be returned to the level indicated by the recipe.

Obtaining an accurate representation of the current state of a plant is very challenging. In addition, determining the current state of a plant from one or more fixed or moveable cameras becomes increasingly difficult as the plant grows, due to one or more of: inability to see “inside” the plant (i.e., within the outermost visible features), due to leaves obscuring the line of sight; inability to see “inside” the plant, due to fixed camera position; and inability to capture images when lights are low or completely off, which can happen during normal operation of the light-bot.

To help obtain an accurate representation of the current state of the plant, a light-bot may include two or more different camera types, which may include visible, infrared (IR), and/or ultraviolet (UV) illumination. Different kinds of light sources allow for tracking different characteristics of a plant that might not be immediately visible. For example:
1. For visible light: shape, height, and width of the plant over time; number, size, shape, and color of leaves and branches; number of branch nodes (which for cannabis may determine the number of flowering nuggets); specific details of nuggets, such as color and size of eminences; and specific details of the leaves, such as blemishes that may be caused by nutrient deficiency.
2. For UV light: the motion of internal nutrient flow within the plant; detection of insects or other predators; and detection of molds and spores not seen in visible light.
3. For IR light: the nitrogen content of the plant leaf (e.g., to detect nitrogen deficiency); the photosynthetic efficiency of the leaves; and the thermal contours of the plant canopy.

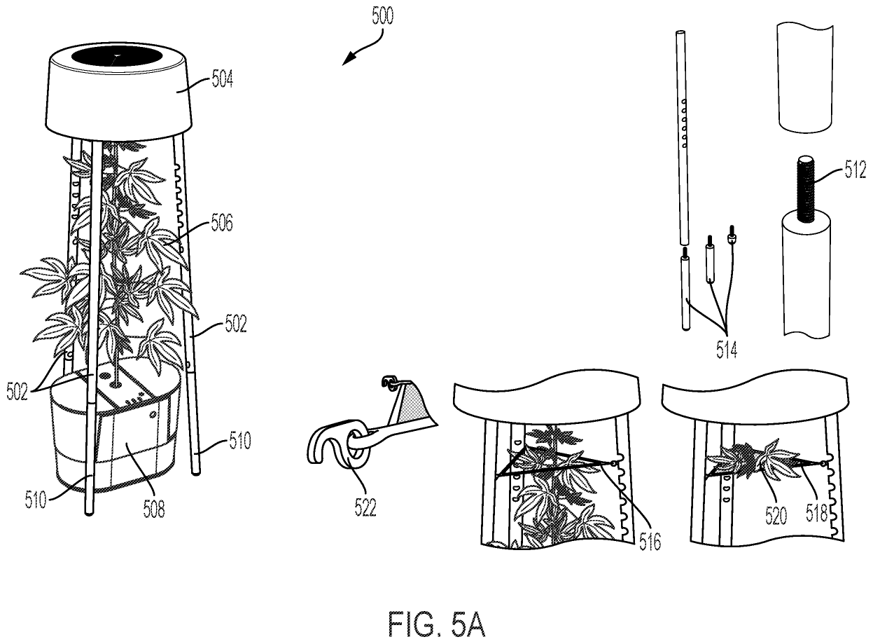

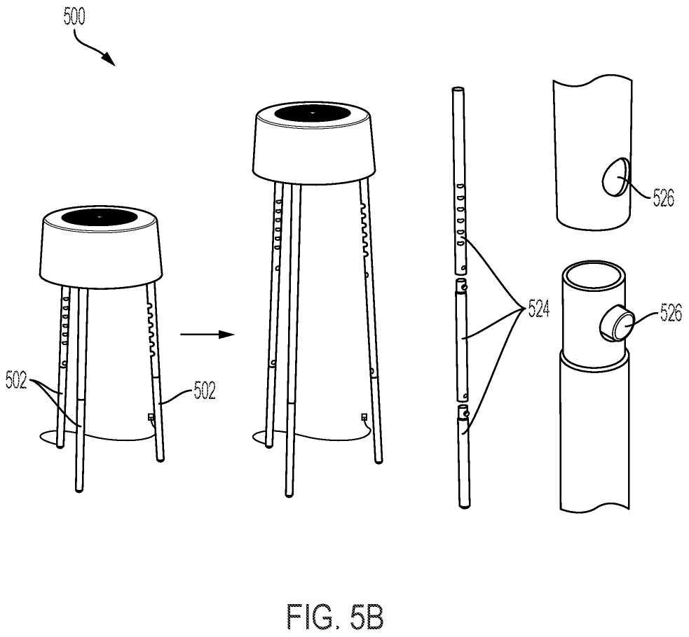

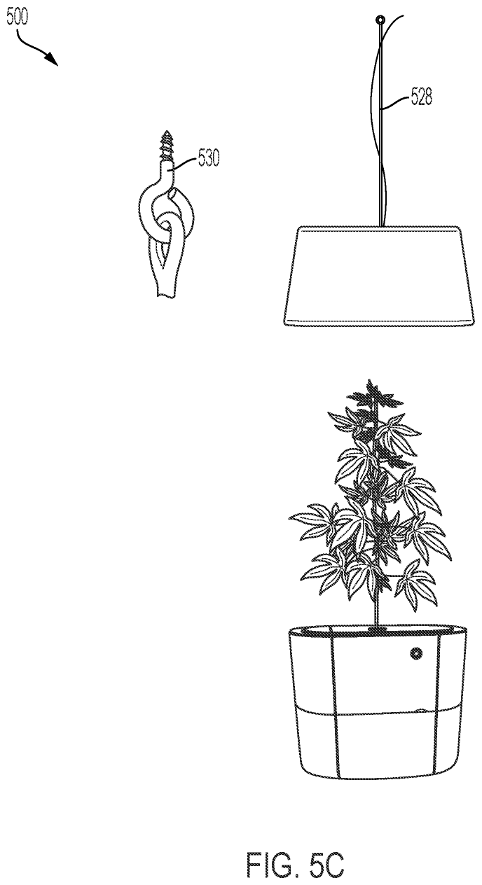

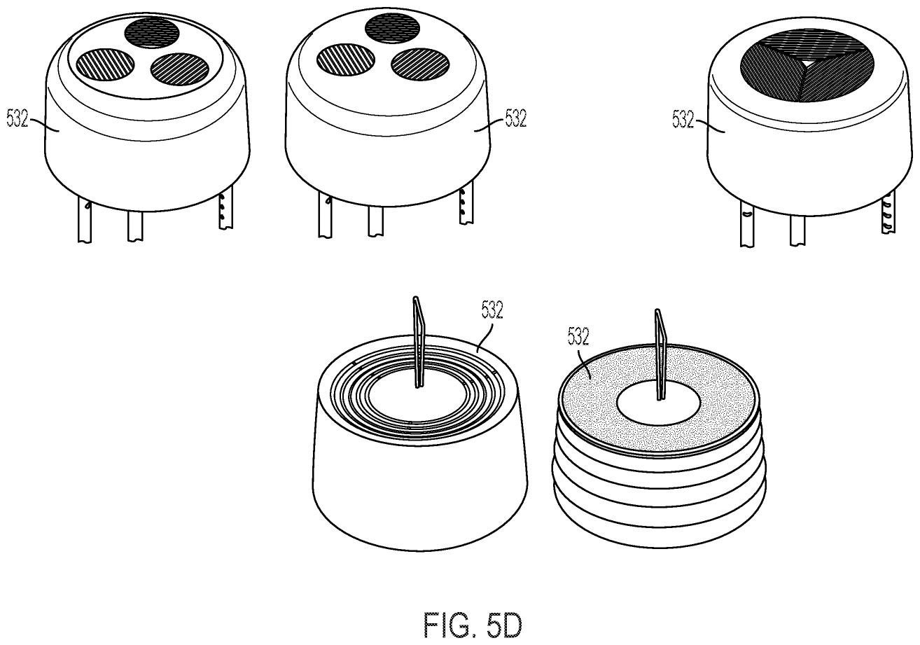

FIGS. 5A-5D illustrate examples of a light-bot according to an embodiment. These examples are provided for illustrative purposes only and should not be construed as limiting one or more embodiments.

In this example, a light-bot 500 includes supporting legs 502, for supporting the light source 504 over the plant 506. The plant 506 may be placed in a grow-bot 508 as shown in FIG. 5A. For example, the light-bot 500 may include three legs 502 as shown in FIG. 5A. Feet 510 may be threaded 512 into each of the legs 502 and may be interchangeable with different foot lengths 514. A trellis 516 may be included to help support the plant 506. A rack 518 may be included for drying harvested plant 520. The trellis 516 and rack 520 may be interchangeable and attachable to the legs 502 using a hook mechanism 522 disposed at each leg 502 or using another suitable connector. As shown in FIG. 5B, the legs 502 may be height-adjustable and may have multiple sections 524 (for example, three sections) that may assemble by snapping together using a snapping mechanism 526 or using another suitable connector. Alternatively or additionally, as shown in FIG. 5C, the light-bot 500 may include a cord 528 that allows it to be mounted from a ceiling (for example, using a ceiling-mounted hook 530 or another suitable connector) or other raised structure, without needing leg supports. FIG. 5D shows examples of different shade configurations 532 for a light-bot 500 according to an embodiment.

### D. Odor Control

The odor produced by cannabis plants is often cited as a reason for not growing cannabis at home. A cannabis plant produces odor as soon as it enters the flowing phase and the odor intensifies throughout the flowering, harvesting, and drying process. The odors are caused by the volatile organic compounds (VOCs) emitted by the chemical terpenes naturally occurring in the cannabis plant, especially in the nuggets that form the final flower product.

One or more embodiments include techniques for reducing odor from growing and/or drying cannabis:
1. Specific varieties of cannabis may be selected that emit less odor. For example, a seed company may describe a cannabis plant as having “mild odor” or “strong odor.”
2. To remove the odor, a filtering system may be employed, using one or more of a variety of filtering mechanisms. Effectiveness of the filtering system may be improved by providing a fan or other mechanism configured to create positive and negative air pressure, to induce airflow around the plant and direct odorous air surrounding the plant to flow through the filtering system. For example, a fan may create positive pressure that directs air through hollow legs of the light-bot. Slots and/or holes cut into the hollow legs may direct the air toward the plant and upwards toward the filtering mechanism. The negative air pressure of the fan may create negative air pressure at the entrance to the filtering mechanism.
3. As an example of a filtering mechanism, air surrounding the plant may be filtered through an activated carbon or polyester/carbon filter to absorb the odors into the carbon.
4. The air surrounding the plant may be filtered by ionizing the incoming airflow. This approach selectively charges the VOC molecules more than the air molecules, by passing the surrounding air through a conductive porous membrane and collecting them on a static or moving conductive screen or mesh with the opposite polarity. The uncharged molecules pass through the collecting membrane untouched, while the charged VOC molecules adhere to the collecting surface.
5. The air surrounding the plant may be filtered by ionizing the incoming airflow, then passing it through a surfactant mist with an opposite charge. This approach causes the VOCs to be attracted to the surfactant, and when they meet, to be encapsulated by the surfactant. These “heavier” encapsulated VOCs can then be removed from the airflow.

Filtering techniques described herein may be used separately or together. One or more filtering techniques may be optimized for one or more specific varieties of plant (e.g., one or more specific varieties of cannabis). A filtering technique needs to be effective only for one plant grow cycle, as it can be replaced after each grow cycle. A filter with a longer life may be replaced less frequently.

Filtering techniques include filtering the odor from the air immediately surrounding the plant. To collect this air, one or more fans may be provided to create airflow around and through the plant, to direct the air through a filter (located, for example, in the light-bot). This approach may include:
1. Using the supporting structure of the light to suck or blow clean air from the light support(s) (e.g., the legs supporting the light cover).
2. Using the light supports to suck or blow air from the light cover itself.
3. Filtering dirty air through a filter that includes one or more of: natural and/or synthetic activated charcoal fibers; an air ionizer; and/or a surfactant-based filter.

### E. Machine Learning

In embodiment, a machine learning engine trains a machine learning model to perform one or more operations, e.g., generating and/or modifying recipes for optimal plant growth. Training a machine learning model uses training data to generate a function that, given one or more inputs to the machine learning model, computes a corresponding output. The output may correspond to a prediction based on prior machine learning. In an embodiment, the output includes a label, classification, and/or categorization assigned to the provided input(s). The machine learning model corresponds to a learned model for performing the desired operation(s) (e.g., labeling, classifying, and/or categorizing inputs). A system may use multiple machine learning engines and/or multiple machine learning models for different purposes.

In an embodiment, the machine learning engine may use supervised learning, semi-supervised learning, unsupervised learning, reinforcement learning, and/or another training method or combination thereof. In supervised learning, labeled training data includes input/output pairs in which each input is labeled with a desired output (e.g., a label, classification, and/or categorization), also referred to as a supervisory signal. For example, one or more kinds of plant- and environment-related data described with respect to FIG. 1 above may be labeled with plant growth outcomes (e.g., plant health, numbers of nuggets, etc.). In semi-supervised learning, some inputs are associated with supervisory signals and other inputs are not associated with supervisory signals. In unsupervised learning, the training data does not include supervisory signals. Reinforcement learning uses a feedback system in which the machine learning engine receives positive and/or negative reinforcement in the process of attempting to solve a particular problem (e.g., to optimize performance in a particular scenario, according to one or more predefined performance criteria). In an embodiment, the machine learning engine initially uses supervised learning to train the machine learning model and then uses unsupervised learning to update the machine learning model on an ongoing basis.

In an embodiment, a machine learning engine may use many different techniques to label, classify, and/or categorize inputs. A machine learning engine may transform inputs into feature vectors that describe one or more properties (“features”) of the inputs. The machine learning engine may label, classify, and/or categorize the inputs based on the feature vectors. Alternatively or additionally, a machine learning engine may use clustering (also referred to as cluster analysis) to identify commonalities in the inputs. The machine learning engine may group (i.e., cluster) the inputs based on those commonalities. The machine learning engine may use hierarchical clustering, k-means clustering, and/or another clustering method or combination thereof. In an embodiment, a machine learning engine includes an artificial neural network. An artificial neural network includes multiple nodes (also referred to as artificial neurons) and edges between nodes. Edges may be associated with corresponding weights that represent the strengths of connections between nodes, which the machine learning engine adjusts as machine learning proceeds. Alternatively or additionally, a machine learning engine may include a support vector machine. A support vector machine represents inputs as vectors. The machine learning engine may label, classify, and/or categorizes inputs based on the vectors. Alternatively or additionally, the machine learning engine may use a naïve Bayes classifier to label, classify, and/or categorize inputs. Alternatively or additionally, given a particular input, a machine learning model may apply a decision tree to predict an output for the given input. Alternatively or additionally, a machine learning engine may apply fuzzy logic in situations where labeling, classifying, and/or categorizing an input among a fixed set of mutually exclusive options is impossible or impractical. The aforementioned machine learning model and techniques are discussed for exemplary purposes only and should not be construed as limiting one or more embodiments.

### F. General; Computer Systems; Networking

In an embodiment, a system includes one or more devices, including one or more hardware processors, that are configured to perform any of the operations described herein and/or recited in any of the claims.

In an embodiment, one or more non-transitory computer-readable storage media store instructions that, when executed by one or more hardware processors, cause performance of any of the operations described herein and/or recited in any of the claims.

Any combination of the features and functionalities described herein may be used in accordance with an embodiment. In the foregoing specification, embodiments have been described with reference to numerous specific details that may vary from implementation to implementation. Accordingly, the specification and figures are to be regarded in an illustrative rather than a restrictive sense. The sole and exclusive indicator of the scope of the invention, and what is intended by the Applicant to be the scope of the invention, is the literal and equivalent scope of the set of claims that issue from this application, in the specific form in which such claims issue, including any subsequent correction.

In an embodiment, techniques described herein are implemented by one or more special-purpose computing devices (i.e., computing devices specially configured to perform certain functionality). The special-purpose computing device(s) may be hard-wired to perform the techniques and/or may include digital electronic devices such as one or more application-specific integrated circuits (ASICs), field programmable gate arrays (FPGAs), and/or network processing units (NPUs) that are persistently programmed to perform the techniques. Alternatively or additionally, a computing device may include one or more general-purpose hardware processors programmed to perform the techniques pursuant to program instructions in firmware, memory, and/or other storage. Alternatively or additionally, a special-purpose computing device may combine custom hard-wired logic, ASICs, FPGAs, or NPUs with custom programming to accomplish the techniques. A special-purpose computing device may include a desktop computer system, portable computer system, handheld device, networking device, and/or any other device(s) incorporating hard-wired and/or program logic to implement the techniques.

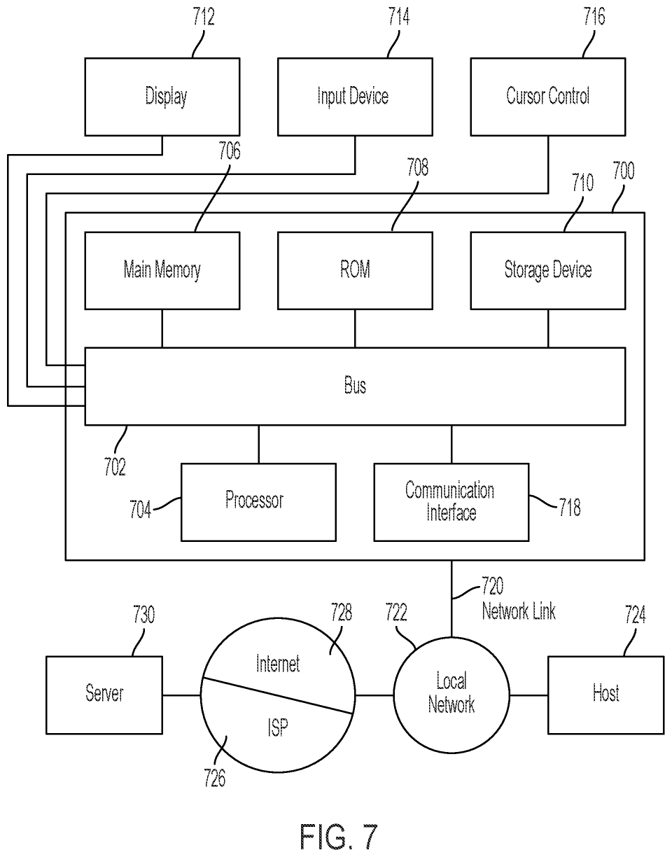

For example, FIG. 7 is a block diagram of an example of a computer system 700 according to an embodiment. Computer system 700 includes a bus 702 or other communication mechanism for communicating information, and a hardware processor 704 coupled with the bus 702 for processing information. Hardware processor 704 may be a general-purpose microprocessor.

Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in one or more non-transitory storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk or optical disk, is provided and coupled to bus 702 for storing information and instructions.

Computer system 700 may be coupled via bus 702 to a display 712, such as a liquid crystal display (LCD), plasma display, electronic ink display, cathode ray tube (CRT) monitor, or any other kind of device for displaying information to a computer user. An input device 714, including alphanumeric and other keys, may be coupled to bus 702 for communicating information and command selections to processor 704. Alternatively or additionally, computer system 700 may receive user input via a cursor control 716, such as a mouse, a trackball, a trackpad, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane. Alternatively or additionally, computer system 7 may include a touchscreen. Display 712 may be configured to receive user input via one or more pressure-sensitive sensors, multi-touch sensors, and/or gesture sensors. Alternatively or additionally, computer system 700 may receive user input via a microphone, video camera, and/or some other kind of user input device (not shown).

Computer system 700 may implement the techniques described herein using customized hard-wired logic, one or more ASICs or FPGAs, firmware, and/or program logic which in combination with other components of computer system 700 causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. Alternatively or additionally, hard-wired circuitry may be used in place of or in combination with software instructions.

The term “storage media” as used herein refers to one or more non-transitory media storing data and/or instructions that cause a machine to operate in a specific fashion. Such storage media may include non-volatile media and/or volatile media. Non-volatile media includes, for example, optical or magnetic disks, such as storage device 710. Volatile media includes dynamic memory, such as main memory 706. Common forms of storage media include, for example, a floppy disk, a flexible disk, hard disk, solid state drive, magnetic tape or other magnetic data storage medium, a CD-ROM or any other optical data storage medium, any physical medium with patterns of holes, a RAM, a programmable read-only memory (PROM), an erasable PROM (EPROM), a FLASH-EPROM, non-volatile random-access memory (NVRAM), any other memory chip or cartridge, content-addressable memory (CAM), and ternary content-addressable memory (TCAM).

A storage medium is distinct from but may be used in conjunction with a transmission medium. Transmission media participate in transferring information between storage media. Examples of transmission media include coaxial cables, copper wire, and fiber optics, including the wires that include bus 702. Transmission media may also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid state drive of a remote computer. The remote computer may load the instructions into its dynamic memory and send the instructions over a network, via a network interface controller (NIC), such as an Ethernet controller or Wi-Fi controller. A NIC local to computer system 700 may receive the data from the network and place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722, and communication interface 718.

The received code may be executed by processor 704 as it is received, and/or stored in storage device 710, or other non-volatile storage for later execution.

In an embodiment, a computer network provides connectivity among a set of nodes running software that utilizes techniques as described herein. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (for example, a request to execute a particular application and/or retrieve a particular set of data). A server process responds by executing the requested service and/or returning corresponding data.

A computer network may be a physical network, including physical nodes connected by physical links. A physical node is any digital device. A physical node may be a function-specific hardware device. Examples of function-specific hardware devices include a hardware switch, a hardware router, a hardware firewall, and a hardware NAT. Alternatively or additionally, a physical node may be any physical resource that provides compute power to perform a task, such as one that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (for example, a physical network). Each node in an overlay network corresponds to a respective node in the underlying network. Accordingly, each node in an overlay network is associated with both an overlay address (to address the overlay node) and an underlay address (to address the underlay node that implements the overlay node). An overlay node may be a digital device and/or a software process (for example, a virtual machine, an application instance, or a thread). A link that connects overlay nodes may be implemented as a tunnel through the underlying network. The overlay nodes at either end of the tunnel may treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources may be shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). In a hybrid cloud, a computer network includes a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, a system supports multiple tenants. A tenant is a corporation, organization, enterprise, business unit, employee, or other entity that accesses a shared computing resource (for example, a computing resource shared in a public cloud). One tenant (through operation, tenant-specific practices, employees, and/or identification to the external world) may be separate from another tenant. The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In an embodiment, in a multi-tenant computer network, tenant isolation is implemented to ensure that the applications and/or data of different tenants are not shared with each other. Various tenant isolation approaches may be used. In an embodiment, each tenant is associated with a tenant ID. Applications implemented by the computer network are tagged with tenant ID's. Additionally or alternatively, data structures and/or datasets, stored by the computer network, are tagged with tenant ID's. A tenant is permitted access to a particular application, data structure, and/or dataset only if the tenant and the particular application, data structure, and/or dataset are associated with a same tenant ID. As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants. A subscription list may indicate which tenants have authorization to access which applications. For each application, a list of tenant ID's of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels may be used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

What is claimed is:

1. A system comprising:
one or more hardware devices including one or more processors; and
one or more non-transitory computer-readable media storing instructions that, when executed by the one or more processors, cause the one or more processors to perform operations comprising:
receiving status data from a plurality of apparatuses associated with hydroponic cultivation,
applying the status data to a machine learning model to determine one or more hydroponic cultivation parameters, and
transmitting, to one or more apparatuses in the plurality of apparatuses, one or more instructions to modify a hydroponic cultivation process according to the one or more hydroponic cultivation parameters.

2. The system of claim 1, the plurality of apparatuses comprising a plurality of hydroponic cultivation apparatuses.

3. The system of claim 2, the one or more instructions comprising an instruction to modify operation of a water pump.

4. The system of claim 3, the instruction to modify operation of the water pump comprising an instruction to obtain a particular water level in a water receptacle.

5. The system of claim 3, the instruction to modify operation of the water pump comprising an instruction to balance water in a water receptacle, by performing one or more of (a) adjusting a concentration of one or more nutrients in the water, (b) adjusting pH of the water or (c) adjusting total dissolved solids of substances in the water, which may be measured in parts per million (PPM).

6. The system of claim 2, the one or more instructions comprising an instruction to modify operation of a nutrient delivery mechanism.

7. The system of claim 6, the instruction to modify operation of the nutrient delivery mechanism comprising an instruction to modify timing of nutrient deposits by the nutrient delivery mechanism.

8. The system of claim 6, the instruction to modify operation of the nutrient delivery mechanism comprising an instruction to modify amounts of nutrient deposits by the nutrient delivery mechanism.

9. The system of claim 1, the plurality of apparatuses comprising a plurality of lighting apparatuses.

10. The system of claim 9, the one or more instructions comprising an instruction to control operation of one or more light sources.

11. The system of claim 9, the one or more instructions comprising an instruction to control a heat source and/or a dehumidifier for drying harvested plant.

12. The system of claim 1, the plurality of apparatuses comprising a plurality of hydroponic cultivation apparatuses and a plurality of lighting apparatuses.

13. The system of claim 1, the one or more instructions comprising an instruction to modify operation of an environmental control mechanism.

14. The system of claim 1, further comprising:
a data repository configured to store at least the status data.

15. The system of claim 1, the operations further comprising:
transmitting data to be displayed in a user interface of an apparatus in the plurality of apparatuses.

16. The system of claim 1, the operations further comprising:
transmitting data to be displayed in a user interface of a user device communicatively coupled with an apparatus in the plurality of apparatuses.

17. The system of claim 1, the plurality of apparatuses configured to perform hydroponic cultivation according to one or more recipes, the instruction comprising one or more modifications to the one or more recipes.

18. The system of claim 1, the operations further comprising:
analyzing image data received from an apparatus in the plurality of apparatuses to detect appearance of an object in a field of view of one or more cameras; and
initiating an anti-blinding protocol responsive to detecting the appearance of the object.

19. The system of claim 1, the operations further comprising:
analyzing image data received from an apparatus in the plurality of apparatuses to determine a status of a plant.

20. One or more non-transitory computer-readable media storing instructions that, when executed by one or more processors, cause the one or more processors to perform operations comprising:
receiving status data from a plurality of apparatuses associated with hydroponic cultivation;
applying the status data to a machine learning model to determine one or more hydroponic cultivation parameters; and
transmitting, to one or more apparatuses in the plurality of apparatuses, one or more instructions to modify a hydroponic cultivation process according to the one or more hydroponic cultivation parameters.

21. The one or more non-transitory computer-readable media of claim 20, the plurality of apparatuses comprising a plurality of hydroponic cultivation apparatuses.

22. The one or more non-transitory computer-readable media of claim 21, the one or more instructions comprising an instruction to modify operation of a water pump.

23. The one or more non-transitory computer-readable media of claim 22, the instruction to modify operation of the water pump comprising an instruction to obtain a particular water level in a water receptacle.

24. The one or more non-transitory computer-readable media of claim 22, the instruction to modify operation of the water pump comprising an instruction to balance water in a water receptacle, by performing one or more of (a) adjusting a concentration of one or more nutrients in the water, (b) adjusting pH of the water or (c) adjusting total dissolved solids of substances in the water, which may be measured in parts per million (PPM).

25. The one or more non-transitory computer-readable media of claim 21, the one or more instructions comprising an instruction to modify operation of a nutrient delivery mechanism.

26. The one or more non-transitory computer-readable media of claim 25, the instruction to modify operation of the nutrient delivery mechanism comprising an instruction to modify timing of nutrient deposits by the nutrient delivery mechanism.

27. The one or more non-transitory computer-readable media of claim 25, the instruction to modify operation of the nutrient delivery mechanism comprising an instruction to modify amounts of nutrient deposits by the nutrient delivery mechanism.

28. The one or more non-transitory computer-readable media of claim 20, the plurality of apparatuses comprising a plurality of lighting apparatuses.

29. The one or more non-transitory computer-readable media of claim 28, the one or more instructions comprising an instruction to control operation of one or more light sources.

30. The one or more non-transitory computer-readable media of claim 28, the one or more instructions comprising an instruction to control a heat source and/or a dehumidifier for drying harvested plant.

31. The one or more non-transitory computer-readable media of claim 20, the plurality of apparatuses comprising a plurality of hydroponic cultivation apparatuses and a plurality of lighting apparatuses.

32. The one or more non-transitory computer-readable media of claim 20, the one or more instructions comprising an instruction to modify operation of an environmental control mechanism.

33. The one or more non-transitory computer-readable media of claim 20, the operations further comprising:
storing at least the status data in a data repository.

34. The one or more non-transitory computer-readable media of claim 20, the operations further comprising:
transmitting data to be displayed in a user interface of an apparatus in the plurality of apparatuses.

35. The one or more non-transitory computer-readable media of claim 20, the operations further comprising:
transmitting data to be displayed in a user interface of a user device communicatively coupled with an apparatus in the plurality of apparatuses.

36. The one or more non-transitory computer-readable media of claim 20, the plurality of apparatuses configured to perform hydroponic cultivation according to one or more recipes, the instruction comprising one or more modifications to the one or more recipes.

37. The one or more non-transitory computer-readable media of claim 20, the operations further comprising:
analyzing image data received from an apparatus in the plurality of apparatuses to detect appearance of an object in a field of view of one or more cameras; and
initiating an anti-blinding protocol responsive to detecting the appearance of the object.

38. The one or more non-transitory computer-readable media of claim 20, the operations further comprising:
analyzing image data received from an apparatus in the plurality of apparatuses to determine a status of a plant.

39. A method comprising:
receiving status data from a plurality of apparatuses associated with hydroponic cultivation;
applying the status data to a machine learning model to determine one or more hydroponic cultivation parameters; and
transmitting, to one or more apparatuses in the plurality of apparatuses, one or more instructions to modify a hydroponic cultivation process according to the one or more hydroponic cultivation parameters.

40. The method of claim 39, the plurality of apparatuses comprising a plurality of hydroponic cultivation apparatuses.

41. The method of claim 40, the one or more instructions comprising an instruction to modify operation of a water pump.

42. The method of claim 41, the instruction to modify operation of the water pump comprising an instruction to obtain a particular water level in a water receptacle.

43. The method of claim 41, the instruction to modify operation of the water pump comprising an instruction to balance water in a water receptacle, by performing one or more of (a) adjusting a concentration of one or more nutrients in the water, (b) adjusting pH of the water or (c) adjusting total dissolved solids of substances in the water, which may be measured in parts per million (PPM).

44. The method of claim 39, the one or more instructions comprising an instruction to modify operation of a nutrient delivery mechanism.

45. The method of claim 44, the instruction to modify operation of the nutrient delivery mechanism comprising an instruction to modify timing of nutrient deposits by the nutrient delivery mechanism.

46. The method of claim 44, the instruction to modify operation of the nutrient delivery mechanism comprising an instruction to modify amounts of nutrient deposits by the nutrient delivery mechanism.

47. The method of claim 39, the plurality of apparatuses comprising a plurality of lighting apparatuses.

48. The method of claim 47, the one or more instructions comprising an instruction to control operation of one or more light sources.

49. The method of claim 47, the one or more instructions comprising an instruction to control a heat source and/or a dehumidifier for drying harvested plant.

50. The method of claim 39, the plurality of apparatuses comprising a plurality of hydroponic cultivation apparatuses and a plurality of lighting apparatuses.

51. The method of claim 39, the one or more instructions comprising an instruction to modify operation of an environmental control mechanism.

52. The method of claim 39, further comprising:
storing at least the status data in a data repository.

53. The method of claim 39, further comprising:
transmitting data to be displayed in a user interface of an apparatus in the plurality of apparatuses.

54. The method of claim 39, further comprising:
transmitting data to be displayed in a user interface of a user device communicatively coupled with an apparatus in the plurality of apparatuses.

55. The method of claim 39, the plurality of apparatuses configured to perform hydroponic cultivation according to one or more recipes, the instruction comprising one or more modifications to the one or more recipes.

56. The method of claim 39, further comprising:
analyzing image data received from an apparatus in the plurality of apparatuses to detect appearance of an object in a field of view of one or more cameras; and
initiating an anti-blinding protocol responsive to detecting the appearance of the object.

57. The method of claim 39, further comprising:
analyzing image data received from an apparatus in the plurality of apparatuses to determine a status of a plant.
